(19) United States
(12) Patent Application Publication
(10) Pub. No.: US 2009/0213265 A1
(43) Pub. Date: Aug. 27, 2009

(54) SIGNAL INPUTTING APPARATUS AND SIGNAL INPUTTING METHOD

(76) Inventor: Shigeyuki Yamashita, Kanagawa (JP)

Correspondence Address: FROMMER LAWRENCE & HAUG LLP, 745 FIFTH AVENUE, NEW YORK, NY, 10151, US

(21) Appl. No.: 12/388,549

(22) Filed: Feb. 19, 2009

(30) Foreign Application Priority Data
Feb. 22, 2008 (JP) P2008-041995

(51) Int. Cl. H04N 5/04; G06F 1/12

(52) U.S. Cl. 348/500; 713/400; 348/E05.009

(57) ABSTRACT

A signal inputting apparatus that receives first and second input image signals transmitted and extracts image data is provided. The apparatus includes a first interface unit and a second interface unit. The first interface unit is configured to receive a first input image signal transmitted, extract data from the first input image signal, and generate a recovered clock from the first input image signal. The second interface unit is configured to receive a second input image signal transmitted in synchronization with the first input image signal and extract data from the transmitted second input image signal based on the recovered clock supplied from the first interface unit.

### CROSS REFERENCES TO RELATED APPLICATIONS

The present invention contains subject matter related to Japanese Patent Application JP 2008-041995 filed in the Japanese Patent Office on Feb. 22, 2008, the entire contents of which being incorporated herein by reference.

### BACKGROUND OF THE INVENTION

1. Field of the Invention

The present invention relates to a signal inputting apparatus and a signal inputting method for receiving a transmitted image signal and extracting image data therefrom.

2. Description of the Related Art

In recent years, for image signals (video signals) where one frame is formed of 1,920 samples on 1,080 lines, there has been a gradual switch from present HD (High Definition) signals of 1080I (Interlaced) to 1080P (Progressive). Extremely large capacity image devices that can handle several times or several ten times the capacity of a present 1.485 Gbps HD signal, such as a 4K or 8K signal or a signal with a high frame rate of 240P, are also being developed. HD-SDI has been selected as a parallel interface for handling a 4K, 8K, or 240P high-frame-rate signal. Applications where image signals according to HD-SDI format (hereinafter also referred to as “HD-SDI signals”) are transmitted on a plurality of channels between circuit boards using an FPGA (Field Programmable Gate Array) equipped with a parallel interface are also becoming more common.

An FPGA is a programmable LSI (Large Scale Integrated circuit). An FPGA can be used to implement and simulate the design of a microprocessor or an ASIC (Application Specific Integrated Circuit). An FPGA operates slower and is more costly than a special purpose LSI, but operates faster than a circuit simulation carried out by software.

The development of a receiver system and an image pickup system for super-high definition image signals that exceed present HD signals is also progressing. As examples, UHDTV (Ultra High Definition Television) format, which is a next-generation broadcast method with four or sixteen times the number of pixels of the present HD standard, has been proposed to the ITU (International Telecommunication Union) and SMPTE (Society of Motion Picture and Television Engineers) and is in the process of becoming accepted as a standard. According to the image formats proposed to the ITU and SMPTE, image signals are 3840 samples on 2160 lines or 7680 samples on 4320 lines, which is to say, double and four times the number of samples and lines of an image signal with 1920 samples on 1080 lines. In such signals, the format standardized by the ITU is called “LSDI” (Large Screen Digital Imagery) and the format proposed to the SMPTE is called “UHDTV” (Ultra High Definition TV). The signals defined by UHDTV are shown in Table 1 below.

TABLE 1

| | | No. of | | |
|---|---|---|---|---|
| | | luminance | No. of | |
| | | or R′G′B′ | effective | Frame |
| System | | samples per | lines per | Rate |
| Category | System Name | effective line | frame | (Hz) |
| UHDTV1 | 3840×2160/50/P | 3840 | 2160 | 50 |
| | 3840×2160/59.94/P | 3840 | 2160 | 60/1.001 |
| | 3840×2160/60/P | 3840 | 2160 | 60 |
| UHDTV2 | 7680×4320/50/P | 7680 | 4320 | 50 |
| | 7680×4320/59.94/P | 7680 | 4320 | 60/1.001 |
| | 7680×4320/60/P | 7680 | 4320 | 60 |

As an interface for such signals, a method has been proposed that transmits an image signal with 3840 samples and 60 frames according to UHDTV standard using two channels, where a channel is a transmission path with a bitrate of 10 Gbps.

Japanese Unexamined Patent Application Publication No. 2005-328494 discloses a technology for serially transmitting a 3840×2160/30P, 30/1.001P/4:4:4/12-bit signal that is one type of a 4k×2k signal (i.e., a super high definition signal with 4k samples on 2k lines) with a bitrate of 10 Gbps or above. Note that the expression “3840×2160/30P” refers to the “number of pixels in the horizontal direction”×“number of pixels in the vertical direction”/“number of frames per second”. Such notation is used throughout this specification. The notation “4:4:4” indicates the ratio “red signal R:green signal G:blue signal B” when a method that transmits primary color signals is used, and indicates the ratio “luminance signal Y:first color difference signal Cb:second color difference signal Cr” when a method that transmits color difference signals is used.

### SUMMARY OF THE INVENTION

When signals are transmitted at high speed, LVDS (Low Voltage Differential Signaling) or the like is used. When LVDS is used, it is possible to transmit and receive signals at 1.485 Gbps, which is the transmission rate for an HD-SDI signal. In the past, an FPGA has been used as a receiver apparatus for transmitting and receiving HD-SDI signals. However, current FPGAs do not have an interface unit with a sufficient transmission rate for transmitting and receiving a 1.485 Gbps HD-SDI signal. This means that it has been necessary to equip an FPGA with a dedicated input/output interface circuit that operates at high speed (hereinafter such circuit is referred to as a “high-speed input/output interface circuit”). A high-speed input/output interface circuit is formed of special-purpose hardware and the clock frequency of the signals that can be processed is currently in the range of around several hundred Mbps to 3 Gbps.

However, the power consumption of a high-speed input/output interface circuit is extremely high. In addition, to transmit HD-SDI signals on multiple channels, it is necessary to equip an FPGA with a high-speed input/output interface circuit corresponding to each channel. High-speed input/output interface circuits are costly, which means the cost increases as the number of channels is increased. In addition, the power consumption of an FPGA increases as the number of channels increases.

Fundamentally, HD-SDI signals on multiple channels are synchronized for every bit. However, even though the same clock is required for every channel, when each channel passes a high-speed input/output interface circuit, power will be wastefully consumed to generate and transmit the clock used by such high-speed input/output interface circuit. An existing high-speed input/output interface circuit also needs signal lines for the clock, and the data lines and such clock signal lines need to be laid out with equal lengths. This means that there are limitations on the layout of functional blocks.

It is desirable to suitably transmit a multichannel HD-SDI signal using a simplified configuration.

An embodiment of the present invention is suitably applied when receiving first and second input image signals transmitted and extracting image data. A first interface unit that receives input image signals and extracts data is used to extract data from a first input image signal transmitted, and supplies a recovered clock generated from the first input image signal to a second interface unit. The second interface unit that receives input image signals and extracts data is used to extract data from a second input image signal transmitted in synchronization with the first input image signal based on the recovered clock supplied from the first interface unit.

Accordingly, it is possible to transmit HD-SDI signals on multiple channels.

According to an embodiment of the present invention, the first interface unit can supply a recovered clock to the second interface unit. This results in the effects that it is not necessary for the second interface unit to generate the recovered clock and the configuration of the signal input apparatus can be simplified. Also, since it is not necessary to connect a clock line to the first and second interface units and supply a recovered clock, there is a reduction in the number of components. There is also an effect that it is possible to reduce the overall power consumption of a signal inputting apparatus.

### BRIEF DESCRIPTION OF THE DRAWINGS

FIG. 1 is a diagram showing an overall configuration of a camera transmission system for television broadcasting according to an embodiment of the present invention;

FIG. 2 is a block diagram showing an example of an internal configuration of a signal transmitting apparatus in a circuit configuration of a broadcasting camera;

FIGS. 3A to 3C are diagrams showing examples of sample configurations of one frame according to UHDTV Standard;

FIG. 4 is a diagram showing an example of mapping samples included in one frame of a 4k×2k signal onto first to fourth subimages;

FIG. 5 is a diagram showing an example of mapping samples included in one frame of a 4k×2k signal onto first to fourth subimages;

FIG. 6 is a diagram showing an overview of a method of mapping onto 4k×2k HD-SDI signals according to “5.4 Octa Link 1.5 Gbps Class” in SMPTE 435 Part 1;

FIGS. 7A and 7B are diagrams showing an overview of data structures of LinkA, LinkB according to SMPTE 372M;

FIG. 8 is a block diagram showing one example of an internal configuration of a signal inputting unit;

FIG. 9 is a block diagram showing an example of an internal configuration of a first interface unit;

FIG. 10 is a block diagram showing an example of an internal configuration of a second interface unit;

FIGS. 11A to 11E are diagrams showing an example of phase shift processing by a first clock phase shift unit;

FIG. 12 is a diagram showing an example of a relationship between steps and CRC errors;

FIG. 13 is a block diagram showing a configuration of an S/P•scramble•8B/10B unit;

FIGS. 14A and 14B are diagrams showing pathological patterns;

FIG. 15 is a diagram showing wave-like baseline distortion in an AC-coupled transmission system;

FIG. 16 is a diagram showing an XYZ code in the timing reference signal SAV;

FIGS. 17A and 17B are diagrams showing multiplexing carried out by a multiplexing unit;

FIG. 18 is a diagram showing a structure of data formed by a data length converting unit;

FIG. 19 is a diagram showing a structure of data formed by the data length converting unit;

FIG. 20 is a diagram showing a structure of data formed by the data length converting unit;

FIGS. 21A to 21C are diagrams showing a structure of one line of 10.692 Gbps serial digital data generated by a multiplexing-parallel/serial converting unit;

FIG. 22 is a block diagram showing an example of an internal configuration of a signal receiving apparatus in a circuit configuration of a CCU; and

FIG. 23 is a block diagram showing the configuration of an S/P•scramble•8B/10B unit.

### DESCRIPTION OF THE PREFERRED EMBODIMENTS

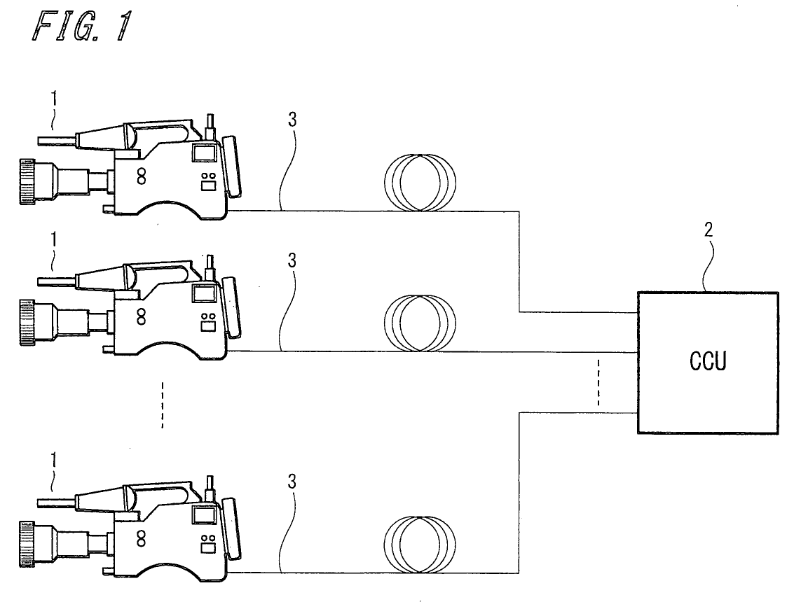

Preferred embodiments of the present invention will now be described with reference to FIGS. 1 to 23.

FIG. 1 is a diagram showing an overall configuration of a camera transmission system for television broadcasting according to an embodiment of the present invention. This camera transmission system includes a plurality of broadcasting cameras 1 and a CCU (camera control unit) 2, with the respective broadcasting cameras 1 being connected to the CCU 2 by fiber optic cables 3

The broadcasting cameras 1 have the same configuration and function as signal transmitting apparatuses 5 that generate and transmit, as a 4k×2k signal (a super high definition signal with 4k samples on 2k lines), a 3840×2160/24P, 25P, 30P/4:4:4, 4:2:2, 4:2:0/10-bit, 12-bit signal that corresponds to LSDI.

The CCU 2 is a unit that controls the broadcasting cameras 1, receives image signals from the respective broadcasting cameras 1, and transmits image signals (return video) for displaying images being picked up by a broadcasting camera 1 on the monitor of another broadcasting camera 1. The CCU 2 functions as a signal receiving apparatus that receives image signals from the broadcasting cameras 1.

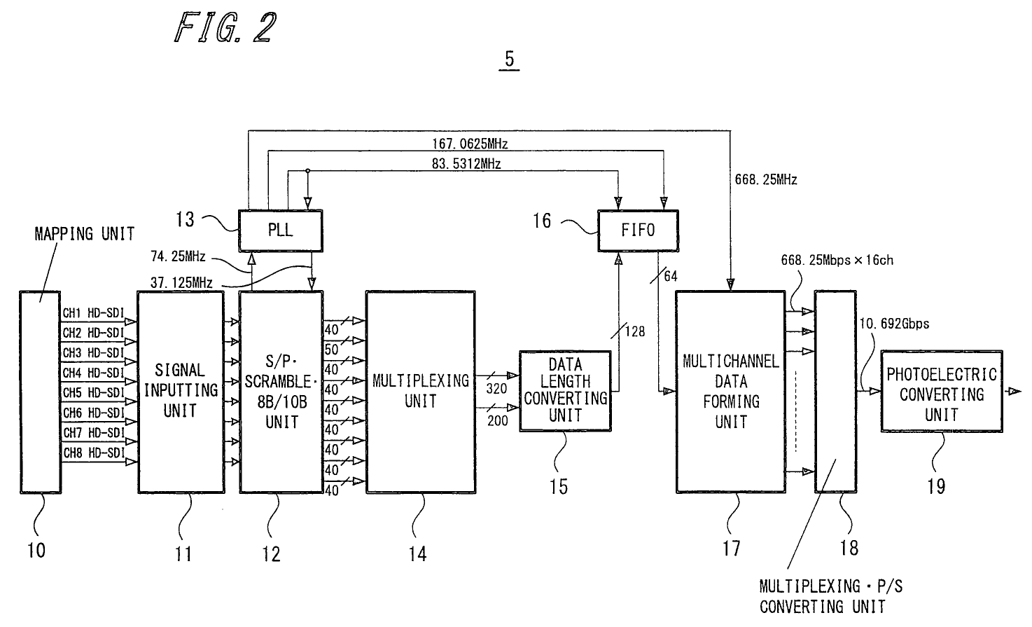

FIG. 2 is a block diagram showing a part, to which the present embodiment relates, of a circuit configuration of a broadcasting camera 1. A 3840×2160/24P, 25P, 30P/4:4:4, 4:2:2, 4:2:0/10-bit, 12-bit signal that has been generated by an image pickup unit and an image signal processing unit (not shown) in the broadcasting camera 1 is transmitted to a mapping unit 10.

The 3840×2160/24P, 25P, 30P/4:4:4, 4:2:2, 4:2:0/10-bit, 12-bit signal is 36 bits wide due to a G data series, a B data series, and an R data series that are each 12 bits of word length being synchronized and aligned in parallel. The frame period may be any of 1/24s, 1/25s or 1/30s, and 2,160 effective line periods are included in one frame period.

A timing reference signal EAV (End of Active Video), a line number LN, an error detection code (CRC), a horizontal blanking interval (a period for auxiliary data and undefined word data), a timing reference signal SAV (Start of Active Video), and an active line that is a period for actual image data are arranged in each effective line period. The number of samples on an active line is 3,840 and G, B, and R image data are respectively arranged on the active lines of the G data series, the B data series, and the R data series.

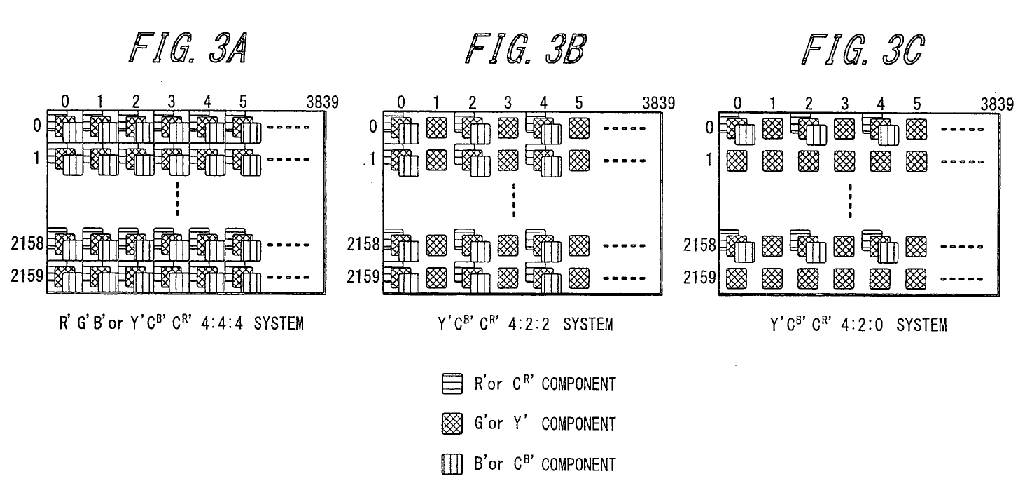

FIGS. 3A to 3C are diagrams showing example sample configurations according to UHDTV standard. As shown in FIGS. 3A to 3C, one frame (hereinafter also referred to as one frame of a 4k×2k signal) used herein is formed of 3840×2160 samples.

There are the following three sample configurations for UHDTV standard. Note that according to SMPTE standard, signals appended with a dash “′”, such as R′, G′, and B′, show signals that have been subjected to gamma correction or the like.

FIG. 3A shows an example of an R′G′B′, Y′Cb′Cr′ 4:4:4 system. In this system, RGB or YCbCr components are included in every sample.

FIG. 3B shows an example of a Y′Cb′Cr′ 4:2:2 system. In this system, YCbCr components are included in every even-numbered sample and a Y component is included in every odd-numbered sample.

FIG. 3C shows an example of a Y′Cb′Cr′ 4:2:0 system. In this system, YCbCr components are included in every even-numbered sample, a Y component is included in every odd-numbered sample, and only Y components (i.e., a state where Cb and Cr are removed) are included in every odd-numbered line.

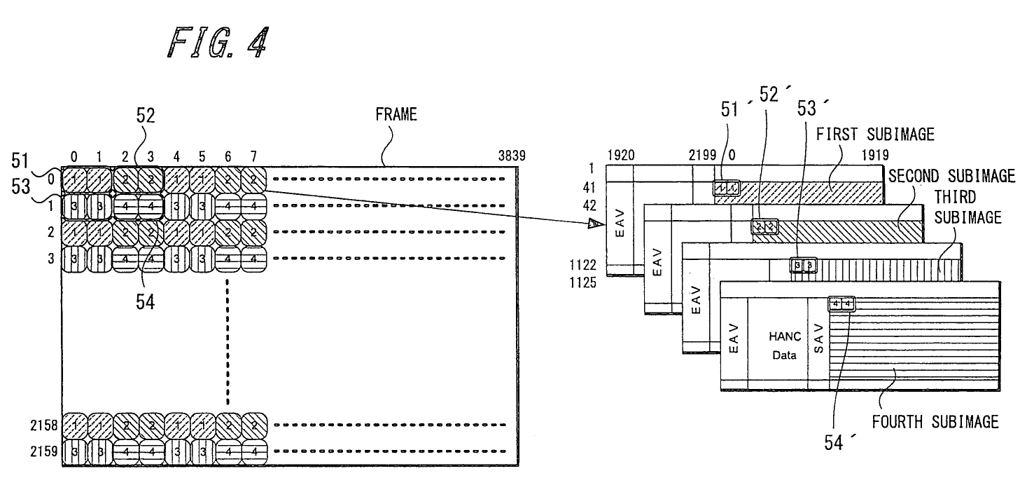

FIG. 4 is a diagram showing an example where the samples that form one frame of a 4k×2k signal are mapped onto first to fourth subimages by the mapping unit 10. The mapping unit 10 according to the present embodiment takes out pixel samples extracted from each frame in an input image signal at intervals of predetermined samples. In the present embodiment, two adjacent samples on the same line are taken at a time. The mapping unit 10 extracts the samples taken out in the same order in each frame and maps the samples onto the active periods of first, second, third, and fourth subimages that are in HD-SDI format.

Here, the mapping unit 10 carries out mapping of sets of two samples on an odd-numbered line of each frame alternately to a first subimage and to a second subimage, and mapping of sets of two samples on an even-numbered line of each frame alternately to a third subimage and a fourth subimage.

As a result, samples that form one frame of a 2k×1k signal are mapped onto each of the first to fourth subimages included in active periods according to HD-SDI format.

In addition, the mapping unit 10 maps the first, second, third, and fourth subimages onto eight channels produced by dividing a transmission channel (LinkA) of a first link and a transmission channel (LinkB) of a second link into four corresponding to the respective subimages.

The mapping unit 10 is a circuit for mapping frames formed by a 3840×2160/24P, 25P, 30P/4:4:4, 4:2:2, 4:2:0/10-bit, 12-bit image signal onto HD-SDI signals with a bitrate of 1.485 Gbps or 1.485 Gbps/1.001 (hereinafter such bitrates are collectively referred to as a “1.485 Gbps”) on eight channels CH1 to CH8 (CH1, CH3, CH5, CH7 on LinkA and CH2, CH4, CH6, CH8 on LinkB) according to SMPTE 435.

The mapping unit 10 according to the present embodiment carries out mapping of an image signal extracted from a frame composed of 3,840 samples on 2,160 lines onto first to fourth subimages and then mapping of the image signals mapped onto the first to fourth subimages onto HD-SDI signals with a bitrate of 1.485 Gbps on eight channels (CH1 to CH8).

As shown in FIG. 4, a plurality of samples are included in a frame composed of a 4k×2k signal. Here, assume that the position of a sample in a frame is expressed as (sample number, line number).

A first sample group 51 that expresses the two adjacent samples (0,0) and (1,0) on the 0^{th} line are mapped onto (0,42), (1,42) in the first subimage and are expressed as the first sample group 51′.

A second sample group 52 that expresses the two adjacent samples (2,0) and (3,0) on the 0^{th} line are mapped onto (0,42), (1,42) in the second subimage and are expressed as the second sample group 52′.

A third sample group 53 that expresses the two adjacent samples (0,1) and (1,1) on the 1^{st} line are mapped onto (0,42), (1,42) in the third subimage and are expressed as the third sample group 53′.

A fourth sample group 54 that expresses the two adjacent samples (2,1) and (3,1) on the 1^{st} line are mapped onto (0,42), (1,42) in the fourth subimage and are expressed as the fourth sample group 54′.

Specific examples of one frame of a 4k×2k signal and mapping in a case where the position of a sample included in the first to fourth subimages is expressed as (sample number, line number) will now be described with reference to FIG. 5. FIG. 5 shows an example of mapping where first to fourth subimages are extracted.

As shown in FIG. 5, the values i, 2i−1, and 2i in the line direction and the values j, 2j−1, and 2j in the sample direction have been added to one frame in a 4k×2k signal.

In the same way, the value i in the line direction and the value j in the sample direction have been added to the first to fourth subimages.

When two adjacent samples on the same line are set as a sample group, the mapping unit 10 maps a first sample group that is arranged at a position of the (2j−1)^{th} sample group (where j is a natural number) on the (2i−1)^{th} line (where i is a natural number) of a frame onto a position of the j^{th} sample group on the i^{th} line of the first subimage.

The mapping unit 10 also maps a second sample group that is arranged at a position of the 2j^{th} sample group on the (2i−1)^{th} line of a frame onto a position of the j^{th} sample group on the i^{th} line of the second subimage.

The mapping unit 10 also maps a third sample group that is arranged at a position of the (2j−1)^{th} sample group on the 2i^{th} line of a frame onto a position of the j^{th} sample group on the i^{th} line of the third subimage.

The mapping unit 10 also maps a fourth sample group that is arranged at a position of the 2j^{th} sample group on the 2i^{th} line of a frame onto a position of the j^{th} sample group on the i^{th} line of the fourth subimage.

Samples are mapped in this way for the following reason.

A frame is formed according to a format which is one of RGB, YCbCr 4:4:4, YCbCr 4:2:2, and YCbCr 4:2:0.

It is preferable if one frame is transmitted using one HD-SDI signal. However, the amount of data will normally be too large, which makes it difficult to transmit one frame using a single HD-SDI signal. For this reason, it is necessary to suitably extract the samples (i.e., information including the image signal) of a frame and transmit a plurality of subimages.

As shown in FIG. 3A, when a frame is formed of RGB or YCbCr 4:4:4, it will be possible to reproduce the original image regardless of what samples are extracted.

As shown in FIG. 3B, when a frame is formed of YCbCr 4:2:2, odd-numbered samples only include information (Y) on a luminance signal. This means that by mapping samples onto subimages so that each odd-numbered sample is grouped together with an adjacent even-numbered sample (that will include CbCr), it will be possible to directly reproduce an image from a subimage in a state where the resolution has dropped compared to the original image of the frame.

As shown in FIG. 3C, when a frame is formed of YCbCr, 4:2:0, odd-numbered samples only include information (Y) on a luminance signal. In addition, odd-numbered lines only include information (Y) on the luminance signal. This means that by mapping samples onto subimages so that each odd-numbered sample is grouped together with an adjacent even-numbered sample (that will include CbCr), it will be possible to directly reproduce an image from a subimage in a state where the resolution has dropped compared to the original image of the frame. Also, although the third and fourth subimages are composed of only information (Y) on the luminance signal, when a reproduced image is viewed, it is not problematic if such image only includes luminance components.

By mapping samples onto the first to fourth subimages, it is possible to transmit the image on a dual link (i.e., via two HD-SDI signals). This means that the samples mapped onto the first to fourth subimages can be transmitted using a total of eight HD-SDI signals.

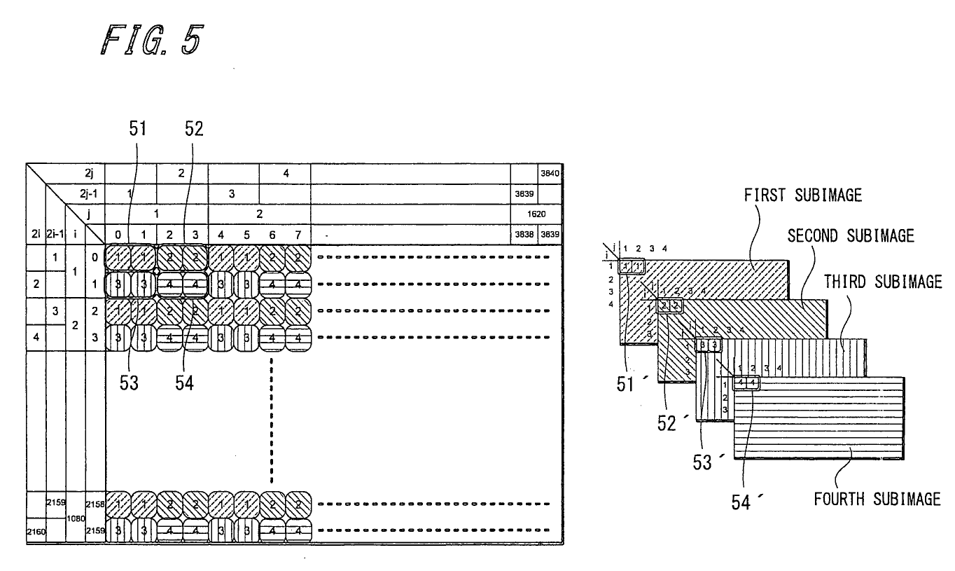

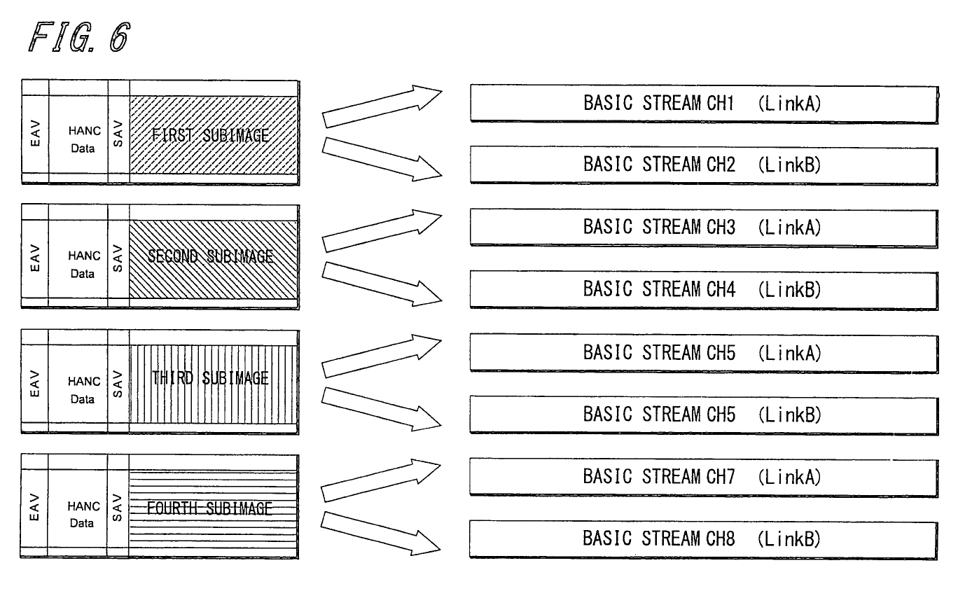

FIG. 6 is a diagram showing an example where the first to fourth subimages onto which the samples have been mapped are mapped onto LinkA or LinkB.

SMPTE 435 is a standard for a 10G interface that encodes a multichannel HD-SDI signal in two-sample units (forty bits) according to 8B/10B encoding to convert the samples to 50 bits, multiplexes the samples on the respective channels, and serially transmits the resulting signals at a bitrate of 10.692 Gbps or 10.692 Gbps/1.001 (hereinafter such bitrates are collectively referred to as “10.692 Gbps”). A technique for mapping a 4k×2k signal onto an HD-SDI signal is shown in FIG. 3, FIG. 4, and FIGS. 6 to 8 in “5.4 Octa Link 1.5 Gbps Class” of “SMPTE 435 Part 1”.

As shown in FIG. 6, CH1 (LinkA) and CH2 (LinkB), CH3 (LinkA) and CH4 (LinkB), CH5 (LinkA) and CH6 (LinkB), and CH7 (LinkA) and CH8 (LinkB) are respectively formed from the mapped first to fourth subimages according to SMPTE 372M (Dual Link).

The mapping unit 10 according to the present embodiment extracts two samples at a time in the line direction from a 3840×2160/24P, 25P, 30P/4:4:4, 4:2:2, 4:2:0/10-bit, 12-bit signal as one sample and multiplexes such samples in HD-SDI active periods. Since the respective samples can be mapped onto 1920×1080/24P, 25P, 30P/4:4:4, 4:2:2, 4:2:0/10-bit, 12-bit signals on four channels, it is possible to transmit the samples using an existing HD-SDI dual link. In addition, it is possible to multiplex and transmit the samples at 10.692 Gb/s.

In such signals, by assigning “200h” (10-bit system) or “800h” (12-bit system) that are default values of Cch for the “0” of “4:2:0”, such signals can be handled as the equivalent of 4:2:2 signals. It is also possible to use four channels on LinkA to transmit a 4:2:2/10-bit or a 4:2:0/10-bit signal without using LinkB. With a 10.692 Gb/s serial interface, CH1 is required for clock synchronization, when CH2 to CH8 are not connected, the channels CH2 to CH8 are filled and transmitted as D0.0.

Signals (see FIG. 6) mapped onto eight channels of HD-SDI correspond to (Quad link 292)×2ch, which is the equivalent of a 1920×1080/50P, 60P/4:4:4, 4:2:2, 4:2:0/12-bit signal.

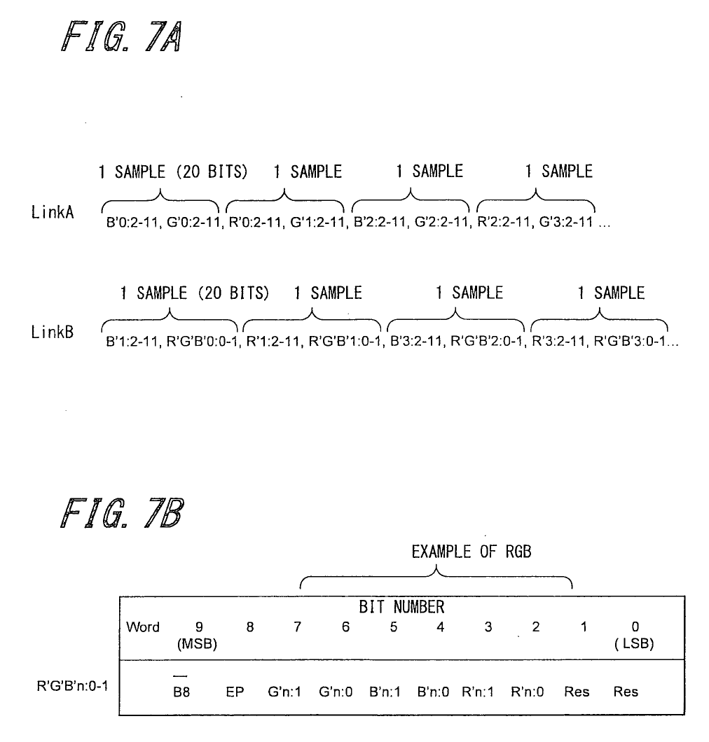

The data structure of LinkA, LinkB is shown in Table 2 and FIG. 6 of SMPTE 372M, and an overview thereof is shown in FIGS. 7A and 7B. As shown in FIG. 7A, on LinkA, one sample is expressed by 20 bits and every bit expresses an RGB value. On LinkB also, one sample is expressed by 20 bits as shown in FIG. 7A, but as shown in FIG. 7B, in the 10-bit R′G′B′n:0-1, only the six bits with the bit numbers 2 to 7 express an RGB value. Accordingly, the number of bits that express the RGB value in one sample is sixteen.

The HD-SDI signals on CH1 to CH8 that have been mapped in this way by the mapping unit 10 are transmitted to an S/P•scramble•8B/10B unit 12 via a signal inputting unit 11 that receives differentially transmitted image signals and extracts the image data (see FIG. 2).

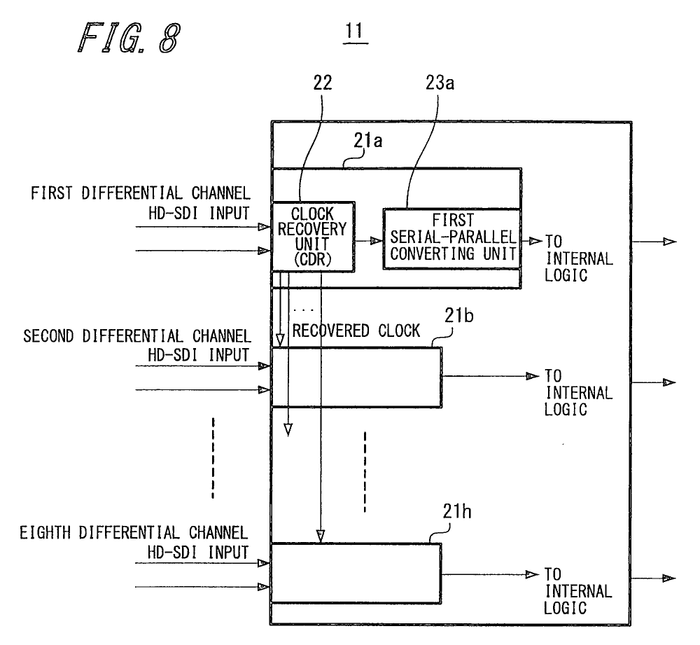

FIG. 8 is a block diagram that shows a simplified configuration of the signal inputting unit 11.

As shown in FIG. 6, the mapping unit 10 according to the present embodiment maps the subimages 1 to 4 onto dual link HD-SDI. Accordingly, the mapping unit 10 can map and transmit pixel samples on a total of eight HD-SDI channels.

The signal inputting unit 11 is formed of an FPGA (Field Programmable Gate Array), for example, and is a block that receives HD-SDI signals on eight channels (CH1 to CH8) from the mapping unit 10. The FPGA includes a dedicated high-speed input/output port and general-purpose (low-speed) input/output ports.

It is expected that a next generation FPGA will be capable of transmitting and receiving HD-SDI signals that are transmitted at a speed of 1.485 Gbps using an input/output port used for standard data transmission. However, when data is fetched, a serial 1.485 GHz clock that is synchronized to the input data is required. To achieve a matching phase for a data line and a clock signal line, it is necessary for signal lines for data and the clock to have the same length.

For this reason, the signal inputting unit 11 according to the present embodiment includes the blocks described below.

The signal inputting unit 11 includes a first interface unit 21a that receives the HD-SDI signal (input image signal) on channel CH1 that has been differentially transmitted and extracts the data. In the same way, the signal inputting unit 11 includes a second interface unit 21b to an eighth interface unit 21h that respectively receive the HD-SDI signals on CH2 to CH8 that have been differentially transmitted and extract data.

The first interface unit 21a is assigned to the dedicated high-speed input/output port of the FPGA. On the other hand, the second interface unit 21b to the eighth interface unit 21h are assigned to general purpose input/output ports of the FPGA. This means that the FPGA only needs to have at least one dedicated high-speed input/output port, and therefore the cost of the FPGA can be suppressed. As a result, the cost of the signal inputting unit 11 itself can be suppressed.

The first interface unit 21a includes a clock recovery unit 22 that generates a clock from the HD-SDI signal that is serial data on CH1 and a first serial/parallel converting unit 23a that carries out wave shaping based on a clock supplied from the clock recovery unit 22 to convert the HD-SDI signal (serial data) on CH1 to parallel data. The clock generated by the clock recovery unit 22 is called a “recovered clock”. As one example, the clock recovery unit 22 is a functional block formed of a CDR (Clock Data Recovery). The first interface unit 21a supplies the generated recovered clock to the second interface unit 21b to the eighth interface unit 21h.

On the other hand, the second interface unit 21b includes a second serial/parallel converting unit 23b (described later with reference to FIG. 10) that converts the HD-SDI signal (serial data) on CH2 to parallel data based on the recovered clock supplied from the clock recovery unit 22.

The remaining interface units up to the eighth interface unit 21h have the same block configuration as the second interface unit 21b.

The operation of the signal inputting unit 11 will now be described.

The signal inputting unit 11 is capable of inputting and outputting 1.485 Gbps HD-SDI signals. When a synchronized multichannel HD-SDI signal is transmitted, the HD-SDI signal on CH1 passes through the first interface unit 21a that operates at high speed and the data therein is reproduced. At this time, the clock recovery unit 22 in the signal inputting unit 11 recovers a clock from the input serial data.

The signal inputting unit 11 carries out waveform shaping on the input data at the timing of the recovered clock using a waveform shaping unit, described later. Subsequently, the signal inputting unit 11 carries out serial/parallel conversion on the input data that has been subjected to waveform shaping, and transmits the data to an internal signal processing circuit, not shown, with a reduced transmission rate. On the other hand, the first interface unit 21a supplies the recovered clock that has been extracted to the second interface unit 21b to the eighth interface unit 21h.

In the signals transmitted and received between the mapping unit 10 and the signal inputting unit 11, the signals on CH2 to CH8 are differentially transmitted in synchronization with the HD-SDI signal on CH1 and are inputted into the interface units 21b to 21h. The image signals on CH2 to CH8 in HD-SDI format are transmitted as LVDS signals that have low power consumption. The second interface unit 21b to the eighth interface unit 21h receive the recovered clock from the first interface unit 21a. The second interface unit 21b to the eighth interface unit 21h adjust the phase of the inputted LSDI signals based on the recovered clock that has been received and then extract data from the signals.

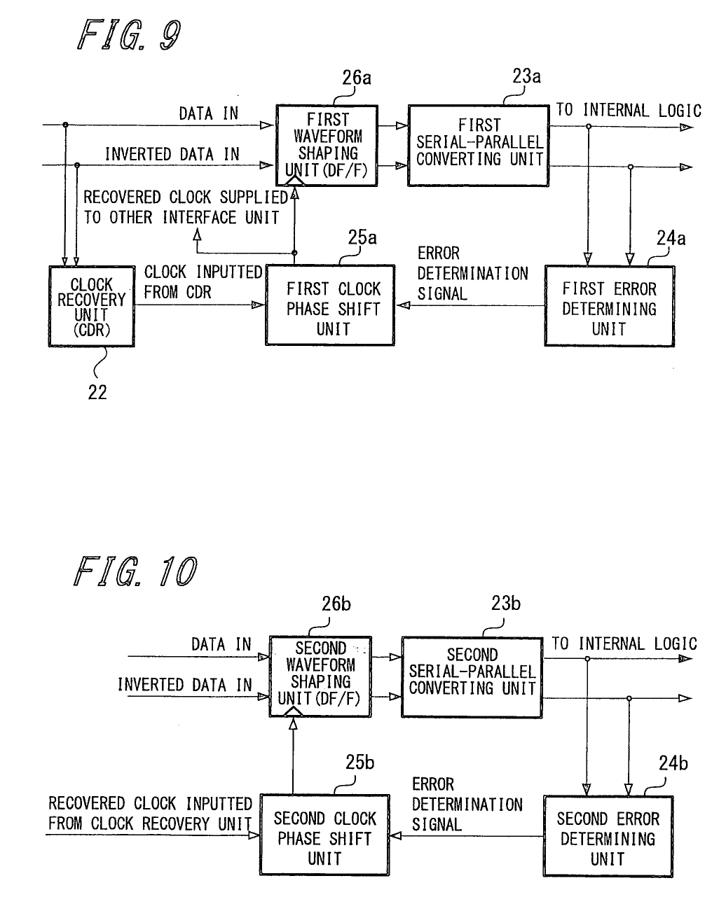

FIG. 9 shows an example of the internal configuration of the first interface unit 21a.

The HD-SDI signal on CH1 that is a pair of data and inverted data is inputted into a first waveform shaping unit 26a, which shapes the waveform of the input data, and the clock recovery unit 22.

The clock recovery unit 22 generates the recovered clock from the received input image signal. Subsequently, the clock recovery unit 22 supplies the recovered clock to a first clock phase shift unit 25a.

The first clock phase shift unit 25a shifts the phase of the supplied recovered clock by predetermined steps. At this point, the first clock phase shift unit 25a decides, based on an error determination signal generated from CRC errors detected by a CRC error detection method, the output phase for outputting the recovered clock generated by the clock recovery unit 22 to a first waveform shaping unit 26a at a center position of the input data where there are zero or a minimum number of CRC errors and there is the largest phase margin.

The first clock phase shift unit 25a supplies the decided recovered clock to the first waveform shaping unit 26a and the second interface unit 21b to the eighth interface unit 21h.

The first waveform shaping unit 26a is a functional block formed, for example, of a D flip-flop. The first waveform shaping unit 26a shapes the data waveform of the input image signal based on the recovered clock supplied from the first clock phase shift unit 25a. The first waveform shaping unit 26a supplies the shaped input data to the first serial/parallel converting unit 23a. At this time, the data supplied to the first serial/parallel converting unit 23a is serial data.

The first serial/parallel converting unit 23a converts the shaped input serial data to parallel data. The data that has been converted from serial to parallel is supplied to internal logic circuits, not shown, and a first error determining unit 24a.

The first error determining unit 24a detects CRC errors according to a CRC error detection method. Subsequently, the error determination signal generated based on the presence or absence of detected CRC errors is supplied to the first clock phase shift unit 25a. The error determination signal is generated for each shifted step.

FIG. 10 shows an example of the internal configuration of the second interface unit 21b.

Since the configurations of the third interface unit 21c to the eighth interface unit 21h are the same as the configuration of the second interface unit 21b, detailed description thereof is omitted.

The recovered clock outputted from the clock recovery unit 22 in the first interface unit 21a is inputted into a second clock phase shift unit 25b via the first clock phase shift unit 25a. The second clock phase shift unit 25b shifts the phase of the supplied clock signal by predetermined steps. At this point, the second clock phase shift unit 25b decides, based on an error determination signal generated from CRC errors detected by a CRC error detection method carried out by a second error determining unit 24b, the output phase for outputting the recovered clock, which was generated by the clock recovery unit 22 and supplied from the first clock phase shift unit 25a, to a second waveform shaping unit 26b at a center position of the input data where there are zero or a minimum number of CRC errors and there is the largest phase margin.

The clock decided by the second clock phase shift unit 25b is supplied to a second waveform shaping unit 26b.

The second waveform shaping unit 26b is a functional block formed, for example, of a D flip-flop. The second waveform shaping unit 26b shapes the data waveform of the input image signal based on the clock supplied from the second clock phase shift unit 25b. The second waveform shaping unit 26b supplies the shaped input data to the second serial/parallel converting unit 23b. At this time, the data supplied to the second serial/parallel converting unit 23b is serial data.

The second serial/parallel converting unit 23b converts the shaped input serial data to parallel data. The data that has been converted from serial to parallel is supplied to internal logic circuits, not shown, and a second error determining unit 24b.

The second error determining unit 24b detects CRC errors according to a CRC error detection method. Subsequently, the error determination signal generated based on the presence or absence of detected CRC errors is supplied to the second clock phase shift unit 25b.

Typically, all of the image signals in an image system are synchronized. Therefore, the input image signals on all eight channels are synchronized. In this case, the first interface unit 21a distributes the clock recovered from the HD-SDI inputted on the first channel to the second interface unit 21b to the eighth interface unit 21h. The phase of the recovered clock distributed to the second interface unit 21b to the eighth interface unit 21h is automatically adjusted to match a center part of the data. Accordingly, the first waveform shaping unit 26a can carry out waveform shaping on the input data at the timing of the recovered clock and transmit a signal to the first serial/parallel converting unit 23a. The second waveform shaping unit 26b to the eighth waveform shaping unit 26h can also respectively carry out waveform shaping on the input data at the timing of the recovered clock and transmit signals to the second serial/parallel converting unit 23b to the eighth serial/parallel converting unit 23h.

It is expected that in the future, not only interface units that are compliant with high transmission rates but also interface units that are compliant with low transmission rates may have a clock recovery function. In such case, the HD-SDI signal on the first channel is inputted into an interface unit equipped with a clock recovery function. The HD-SDI signals on the other channels may be inputted into interface units that do not have a clock recovery function or interface units whose clock recovery function has been turned off to reduce power consumption.

FIGS. 11A to 11E show examples of phase shifts of a clock carried out by the first clock phase shift unit 25a.

Here, since the phase shift processing for a clock carried out by the second clock phase shift unit 25b to the eighth clock phase shift unit 25h is the same as the processing by the first clock phase shift unit 25a, detailed description thereof is omitted.

FIG. 11A shows an example of an input image signal. The input image signal is differentially transmitted and includes data and inverse data.

FIG. 11B shows an example of the initial phase of the clock.

The first clock phase shift unit 25a supplies the phase (360°) of the clock to the first waveform shaping unit 26a. When doing so, the phase is divided into 128 parts, for example and the phase is successively shifted.

FIG. 11C shows an example of a state where the initial phase of the clock has advanced by one step.

FIG. 11D shows an example of a state where the initial phase of the clock has advanced by two steps.

The first waveform shaping unit 26a carries out waveform shaping on the input data at the timing of the clock and transmits the shaped input data to the first serial/parallel converting unit 23a. The first error determining unit 24a determines errors in the data outputted from the first serial-parallel converting unit 23a for a fixed period using the CRC appended immediately after the EAV included in the HD-SDI. After CRC errors have been determined, the first clock phase shift unit 25a shifts the phase forward by one step (a further 1/128 of the phase) and another detection process for CRC errors is carried out.

FIG. 11E shows an example of a state after the clock phase has been adjusted.

As a result of shifting the clock phase, rising and falling edges of the clock match the center positions of the input data. Accordingly, the first interface unit 21a will be able to correctly read the data, carry out waveform shaping, and transmit signals to the internal logic that comes next.

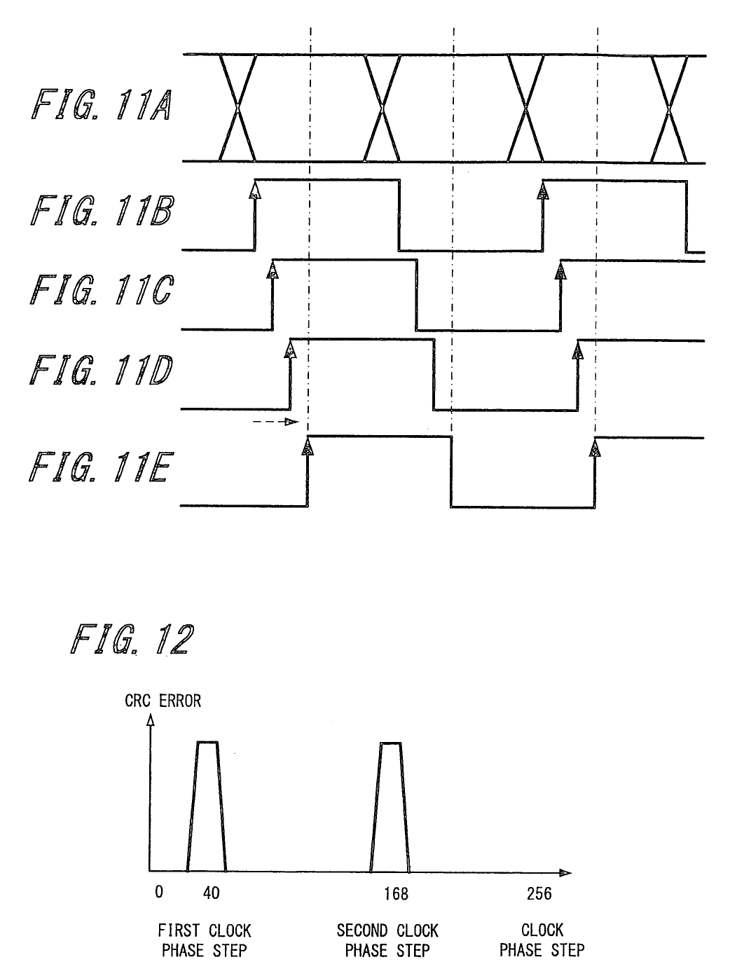

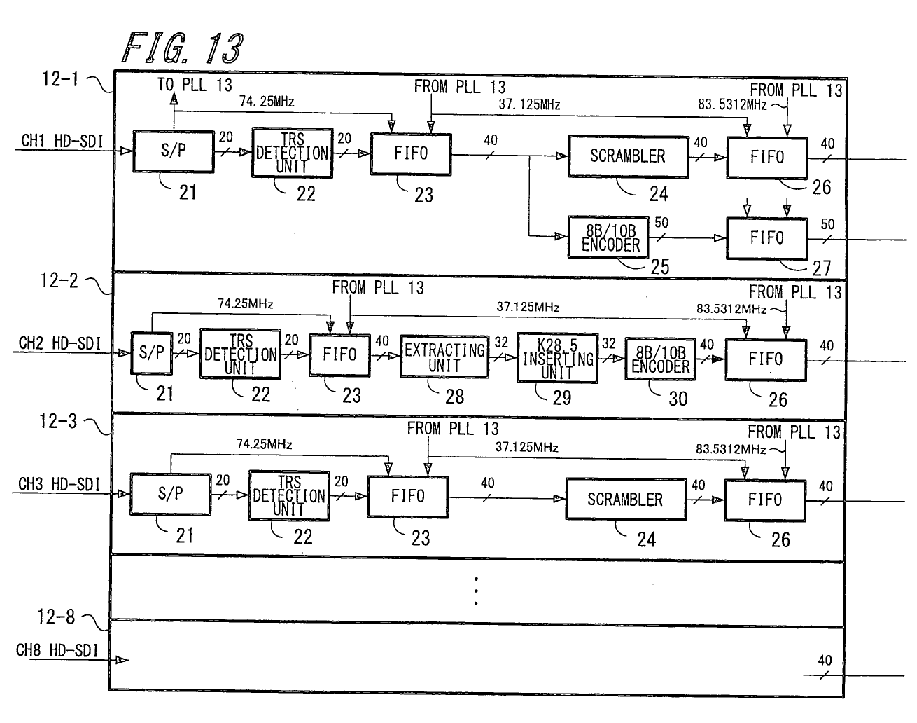

FIG. 12 shows an example of the relationship between the number of CRC errors and shifts in clock phase.

The vertical axis shows the probability that a CRC error will occur and the horizontal axis shows the clock phase steps. As shown in FIG. 12, the probability that a CRC error will occur rises when the clock phase step is “40” and “168”. The probability that a CRC error will occur is related to transactions for the input data. That is, when a transaction occurs for the input data, the probability that a CRC error will occur tends to rise. Therefore, by finding clock phase steps where the probability that a CRC error will occur rises and calculating the difference between consecutive clock phase steps, it is possible to find clock units that correspond to the input data.

The first clock phase shift unit 25a repeatedly shifts the phase of the clock in at least 128×2 steps (i.e., two clock cycle periods). The phase shift is found from the relationship between the clock phase steps and CRC errors shown in FIG. 12 according to Equation (1) below. The first clock phase shift unit 25a can find the center position of the input data from Equation (1). When doing so, the clock phase steps where the probability that a CRC error will occur rises are referred to as the “first and second clock phase steps”.

### Equation (1)

(First Clock Phase Step+Second Clock Phase Step)/2=Center Position of Input Data (1)

From FIG. 12 and Equation (1), the center position of the input data is found as (40+168)/2=104 (clock phase step).

FIG. 13 is a block diagram showing the configuration of the S/P•scramble•8B/10B unit 12. The S/P•scramble•8B/10B unit 12 is composed of eight blocks numbered 12-1 to 12-8 that one-to-one correspond to the channels CH1 to CH8.

In the blocks 12-1, 12-3, 12-5, and 12-7 for the channels CH1, CH3, CH5, and CH7 on LinkA, only the configuration of block 12-1 differs to the configuration of the blocks 12-3, 12-5, and 12-7 and the blocks 12-3, 12-5, and 12-7 have the same configuration (in FIG. 13, the configuration of the block 12-3 is shown but the configurations of the blocks 12-5 and 12-7 are omitted). Conversely, all of the blocks 12-2, 12-4, 12-6, and 12-8 for the channels CH2, CH4, CH6, and CH8 on LinkB have the same configuration (in FIG. 13, the configuration of the block 12-2 is shown but the configurations of the blocks 12-4, 12-6, and 12-8 are omitted). Also, parts that carry out the same processing in each block have been assigned the same reference numerals.

First, the blocks 12-1, 12-3, 12-5, and 12-7 used for LinkA will be described. In the blocks 12-1, 12-3, 12-5, and 12-7, the inputted HD-SDI signals on the channels CH1, CH3, CH5, and CH7 are supplied to respective serial/parallel converting units 21. Each serial/parallel converting unit 21 carries out serial/parallel conversion to convert the HD-SDI signal to parallel digital data with a 20-bit width and a bitrate of 74.25 Mbps or 74.25 Mbps/1.001 (hereinafter such bitrates are collectively referred to as “74.25 Mbps”) and also extracts a 74.25 Mhz clock.

The parallel digital data produced by the serial/parallel conversion by each serial/parallel converting unit 21 is supplied to a TRS detection unit 22. The 74.25 MHz clock extracted by the serial/parallel converting unit 21 is supplied as a write clock to a FIFO memory 23. The 74.25 MHz clock extracted by the serial/parallel converting unit 21 in the block 12-1 is also supplied to a PLL (Phase Locked Loop: phase synchronization circuit) 13 shown in FIG. 2.

The TRS detection unit 22 detects the timing reference signals SAV and EAV from the parallel digital data supplied from the serial/parallel converting unit 21 and establishes bit synchronization and word synchronization based on the detection results.

The parallel digital data that has been processed by the TRS detection unit 22 is supplied to the FIFO memory 23 and is written into the FIFO memory 23 using the 74.25 MHz clock from the serial/parallel converting unit 21.

The PLL 13 shown in FIG. 2 supplies a 37.125 MHz clock produced by dividing the frequency of the 74.25 MHz clock from the serial/parallel converting unit 21 in the block 12-1 into one half as a read clock to the FIFO memory 23 in each of the blocks 12-1 to 12-8 and as a write clock to a FIFO memory 26 in each of the blocks 12-1 to 12-8 and to a FIFO memory 27 in the block 12-1.

The PLL 13 also supplies a 83.5312 MHz clock produced by multiplying the frequency of the 74.25 MHz clock from the serial/parallel converting unit 21 in the block 12-1 by 9/8 as a read clock to the FIFO memory 26 in each of the blocks 12-1 to 12-8 and to a FIFO memory 27 in the block 12-1 and as a write clock to a FIFO memory 16 shown in FIG. 2.

The PLL 13 supplies a 167.0625 MHz clock produced by multiplying the frequency of the 74.25 MHz clock from the serial/parallel converting unit 21 in the block 12-1 by 9/4 as a read clock to the FIFO memory 16 shown in FIG. 2.

The PLL 13 supplies a 668.25 MHz clock produced by multiplying the frequency of the 74.25 MHz clock from the serial/parallel converting unit 21 in the block 12-1 by 9 as a read clock to a multichannel data forming unit 17 shown in FIG. 2.

As shown in FIG. 13, the parallel digital data with a 20-bit width that was written using the 74.25 MHz clock from the serial-parallel converting unit 21 is read from the FIFO memory 23 as parallel digital data with a 40-bit width with two samples as a unit using the 37.125 MHz clock from the PLL 13 in FIG. 2, and such parallel digital data with a 40-bit width is supplied to a scrambler 24. In the block 12-1, the parallel digital data with a 40-bit width read from the FIFO memory 23 is also supplied to an 8B/10B encoder 25.

The scrambler 24 is a self-synchronizing scrambler. The self-synchronizing scrambling method used therein is the method applied in SMPTE 292. The transmitter regards an inputted serial signal as a polynomial, successively divides such signal by the primitive polynomial X⁹+X⁴+1 of order nine, and transmits the resulting quotient so that in statistical terms the mark ratio (i.e., the ratio of ones and zeros) of the transmitted data is around ½. Here, the expression “scrambling” also includes the encryption of a signal using a primitive polynomial. The quotient is also divided by X+1 and then transmitted as data that is polarity free (where the data and the inverse data have the same information). At the receiver, by carrying out processing (descrambling) that multiplies the received serial signal by X+1 and then multiplies by the primitive polynomial X⁹+X⁴+1 described above, the original serial signal is reproduced.

The scrambler 24 does not scramble the entire data on each horizontal line but instead scrambles the data of the timing reference signal SAV, the active line, the timing reference signal EAV, the line number LN, and the error detection code CRC, and does not scramble the data of the horizontal blanking interval. Encoding is carried out with the value of a register in the scrambler set at all zeroes immediately before the timing reference signal SAV, and data up to 10 bits after the error detection code CRC is outputted.

The scrambler 24 carries out such processing for the following reason. Although all of the data on every horizontal line is transmitted uninterruptedly with an existing self-synchronizing scrambling method, in the present embodiment, data on the horizontal blanking interval that has been subjected to self-synchronizing scrambling is not transmitted. As a method for doing so, it is possible to use a method that scrambles all of the data on every horizontal line including the horizontal blanking intervals but does not transmit the data of the horizontal blanking intervals. However, according to this method, since data is not kept continuous for the transmission scrambler and the reception descrambler, when data is reproduced by the descrambler at the receiver, miscalculation of a carry will occur at the final few bits of the CRC, and therefore the error detection code CRC will not be correctly reproduced. Also, although there is a method that can correctly reproduce the CRC by stopping the clock of a scrambler in a horizontal blanking interval where data is not transmitted, when such method is used, there are the problems that the next timing reference signal SAV is necessary when calculating the CRC and that timing control may be difficult.

For this reason, only the data of the timing reference signal SAV, the active line, the timing reference signal EAV, the line number LN, and the error detection code CRC is subjected to scrambling, encoding is carried out with the value in the register in the scrambler 24 set at all zeroes immediately before the timing reference signal SAV, and at least a few bits (as one example, 10 bits) of data that follow the error detection code CRC are outputted.

In the receiver apparatus, by commencing the decoding having set the value in the register in a descrambler at all zeroes immediately before the timing reference signal SAV and carrying out descrambling also on at least a few bits of data that follow the error detection code CRC, it is possible to reproduce the original data by correctly carrying out calculation having considered a carry at the descrambler that is a multiplication circuit.

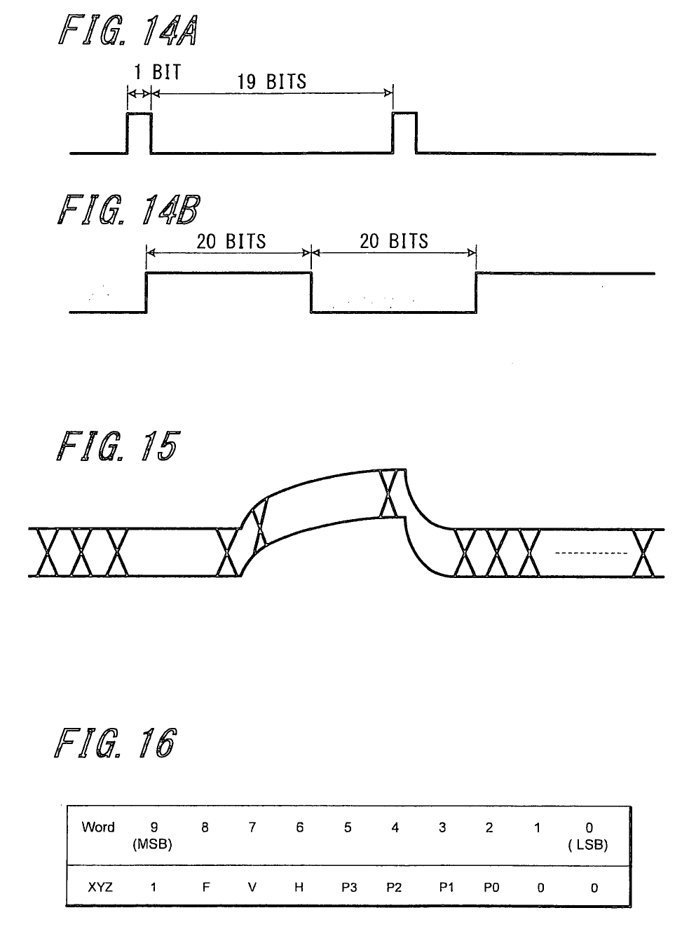

In addition, it has been established from calculation that by setting the value in the register in the scrambler at all zeroes immediately before the timing reference signal SAV, pathological patterns will not appear in the scramble data. The expression “pathological pattern” refers to a signal produced by a self-synchronizing scramble such that on a serial transmission path, “L” continues for 19 bits following one “H” bit (or an inverse thereof) across one horizontal line as shown in FIG. 14A, or such that “L” continues for 20 bits following 20 consecutive “H” bits (or an inverse thereof) as shown in FIG. 14B.

The pattern shown in FIG. 14A and the inverse pattern thereof are patterns with many DC components. Although an AC-coupled transmission system is typically used to achieve a high transmission rate such as 10 Gbps, with an AC-coupled transmission system, wave-like baseline distortion as shown in FIG. 15 occurs when there are many DC components, which makes it necessary to recover the DC components at the receiver apparatus.

Since the pattern shown in FIG. 14B and the inverse pattern thereof have few transitions from zero to one and from one to zero, it is difficult for the receiver apparatus to recover the clock from the serial signal.

On the other hand, as described earlier, since it has been established by calculation that such pathological patterns do not occur when the value of the register in the scrambler is set at all zeroes immediately before the timing reference signal SAV, the signal can be regarded as suitable transmission code.

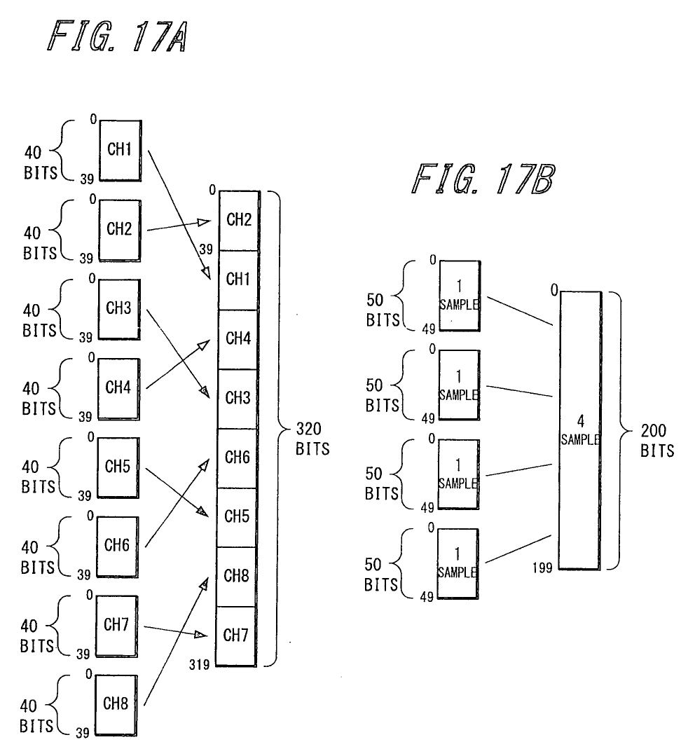

Also, as shown in FIG. 16, the least significant two bits of XYZ (a word used to identify the first field and second field in the same frame and identify the SAV and EAV) that is the final word in the timing reference signal SAV may be (0,0). In such case, scrambling is carried out having changed the value of such least significant two bits on the respective channels CH1, CH3, CH5, and CH7. For example, the scrambler 24 in the block 12-1 carries out scrambling with the least significant two bits left at (0,0). Similarly, the scrambler 24 in the block 12-3 carries out scrambling with the least significant two bits having been replaced with (0,1). The scrambler 24 in the block 12-5 carries out scrambling with the least significant two bits having been replaced with (1,0). The scrambler 24 in the block 12-7 carries out scrambling with the least significant two bits having been replaced with (1,1).

Such processing is carried out for the following reason. When a 3840×2160/24P, 25P, 30P/4:4:4, 4:2:2, 4:2:0/10-bit, 12-bit signal is a flat signal (i.e., when the RGB values are substantially equal across the entire screen), if the data values on all of channels CH1, CH3, CH5, CH7 and channels CH2, CH4, CH6, CH8 are all uniform, EMI (electromagnetic interference) or the like may occur. On the other hand, if scrambling is carried out having changed the value of the least significant two bits of XYZ in the SAV for each channel CH1, CH3, CH5, CH7, in addition to data where the least significant two bits of XYZ are (0,0), the result of dividing (0,1), (1,0), and (1,1) by a generator polynomial will be transmitted as the data after scrambling, and therefore it will be possible to avoid uniformity in the data.

In addition, it has been established from calculation that even if the least significant two bits of XYZ are changed on each channel in this way, by setting the value of the register in the scrambler at all zeroes immediately before the timing reference signal SAV as described earlier, pathological patterns may not occur.

The 40-bit-wide parallel digital data scrambled by the scrambler 24 in this way is written into the FIFO memory 26 using the 37.125 MHz clock from the PLL 13 shown in FIG. 2 and is then read from the FIFO memory 26 as 40-bit-wide data using the 83.5312 MHz clock from the PLL 13 and supplied to the multiplexing unit 14 shown in FIG. 2.

The 8B/10B encoder 25 in the block 12-1 carries out 8-bit/10-bit encoding on only the data of the horizontal blanking interval in the 40-bit wide parallel digital data read from the FIFO memory 23.

The 50-bit-wide parallel digital data that results from the 8-bit/10-bit encoding by the 8B/10B encoder 25 is written into the FIFO memory 27 using the 37.125 MHz clock from the PLL 13 shown in FIG. 2, and is then read from the FIFO memory 27 as the 50-bit-wide data using the 83.5312 MHz clock from the PLL 13 and supplied to the multiplexing unit 14 shown in FIG. 2.

Note that data on the horizontal blanking interval is supplied to the multiplexing unit 14 from only the block 12-1 (that is, only on CH1) and no data on the horizontal blanking interval is supplied to the multiplexing unit 14 from the blocks 12-3, 12-5, 12-7 (that is, on CH3, CH5, CH7) for reasons relating to the limit on the amount of data.

Next, the blocks 12-2, 12-4, 12-6, and 12-8 for LinkB will be described. In the blocks 12-2, 12-4, 12-6, and 12-8, the inputted HD-SDI signals on the channels CH2, CH4, CH6, and CH8 are subjected to the same processing as in the blocks 12-1, 12-3, 12-5, and 12-7 by the serial-parallel converting units 21 and the TRS detection units 22 and are then supplied to extracting units 28.

Each extracting unit 28 is a circuit for extracting the RGB bits (that is, the 16 bits that express an RGB value in the 20 bits in one sample on LinkB shown in FIG. 7B) from only the timing reference signal SAV, the active line, the timing reference signal EAV, the line number LN, and the error detection code CRC in the data on each horizontal line on LinkB.

The 16-bit-wide parallel digital data extracted by the extracting unit 28 is written into the FIFO memory 23 using the 74.25 MHz clock from the serial-parallel converting unit 21 and then read out as 32-bit-wide parallel digital data that has two samples as one unit using the 37.125 MHz clock from the PLL 13 shown in FIG. 2 and supplied to a K28.5 inserting unit 29.

The K28.5 inserting unit 29 inserts two pieces of 8-bit word data at a starting position of the timing reference signal SAV or EAV. When such 8-bit word data is subjected to eight-bit/ten-bit encoding, the data is converted to 10-bit word data that is not used as word data for expressing an image signal (such data is referred to by the codename “K28.5”).

The 32-bit-wide parallel digital data that has been processed by the K28.5 inserting unit 29 is supplied to an 8B/10B encoder 30. The 8B/10B encoder 30 subjects the 32-bit-wide parallel digital data to eight-bit/ten-bit encoding and outputs the result.

The 32-bit-wide parallel digital data having two samples as a unit is subjected to eight-bit/ten-bit encoding by the 8B/10B encoder 30 to achieve compatibility with the most significant 40 bits of a 50-bit “Content ID” according to SMPTE 435 that is a 10G interface standard.

The 40-bit-wide parallel digital data subjected to eight-bit/ten-bit encoding by the 8B/10B encoder 30 has been written into the FIFO memory 26 using the 37.125 MHz clock from the PLL 13 shown in FIG. 2. Subsequently, the data is read from the FIFO memory 26 as 40-bit-wide data using the 83.5312 MHz clock from the PLL 13 and supplied to the multiplexing unit 14 shown in FIG. 2.

The multiplexing unit 14 shown in FIG. 2 multiplexes the 40-bit wide parallel digital data (only data of the timing reference signal SAV, the active line, the timing reference signal EAV, the line number LN, and the error detection code CRC) on the channels CH1 to CH8 read from the FIFO memories 26 in the blocks 12-1 to 12-8 in the S/P•scramble•8B/10B unit 12 to produce 320-bit-wide data. As shown in FIG. 17A, CH2 (subjected to 8-bit/10-bit encoding), CH1 (subjected to self-synchronizing scrambling), CH4 (subjected to 8-bit/10-bit encoding), CH3 (subjected to self-synchronizing scrambling), CH6 (subjected to 8-bit/10-bit encoding), CH5 (subjected to self-synchronizing scrambling), CH8 (subjected to 8-bit/10-bit encoding), and CH7 (subjected to self-synchronizing scrambling) are multiplexed in order in 40-bit units.

In this way, the data that has been subjected to 8-bit/10-bit encoding is sandwiched at intervals of 40 bits by data that has been subjected to self-synchronizing scrambling. Therefore, it is possible to eliminate fluctuations in the mark ratio (the proportion of zeros and ones) depending on the scrambling method and instability in the transitions of 0-1 and 1-0, preventing the pathological patterns described earlier from occurring.

As shown in FIG. 17B, the multiplexing unit 14 multiplexes four samples of 50-bit wide parallel digital data of only the horizontal blanking interval of channel CH1 read from the FIFO memory 27 in the block 12-1 of the S/P•scramble•8B/10B unit 12 to obtain data with a 200-bit width.

The 320-bit wide parallel digital data and the 200-bit-width parallel digital data multiplexed by the multiplexing unit 14 are supplied to a data length converting unit 15. The data length converting unit 15 is formed using a shift register and uses data produced by converting the 320-bit-width parallel digital data to a 256-bit width and data produced by converting the 200-bit-width parallel digital data to a 256-bit width to form 256-bit width parallel digital data. Subsequently, the 256-bit-width parallel digital data is further converted to a 128-bit width.

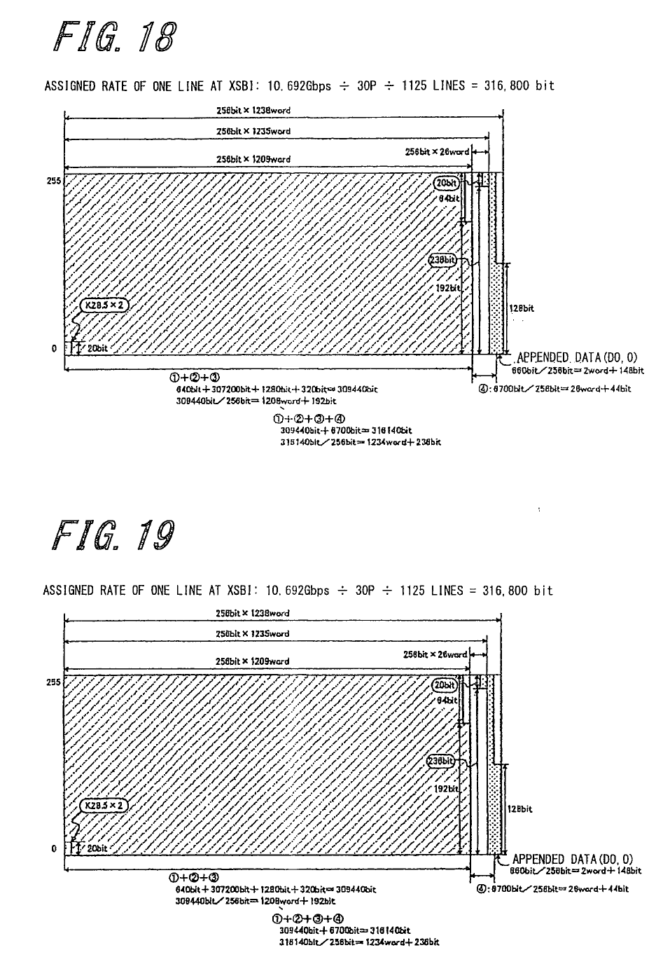

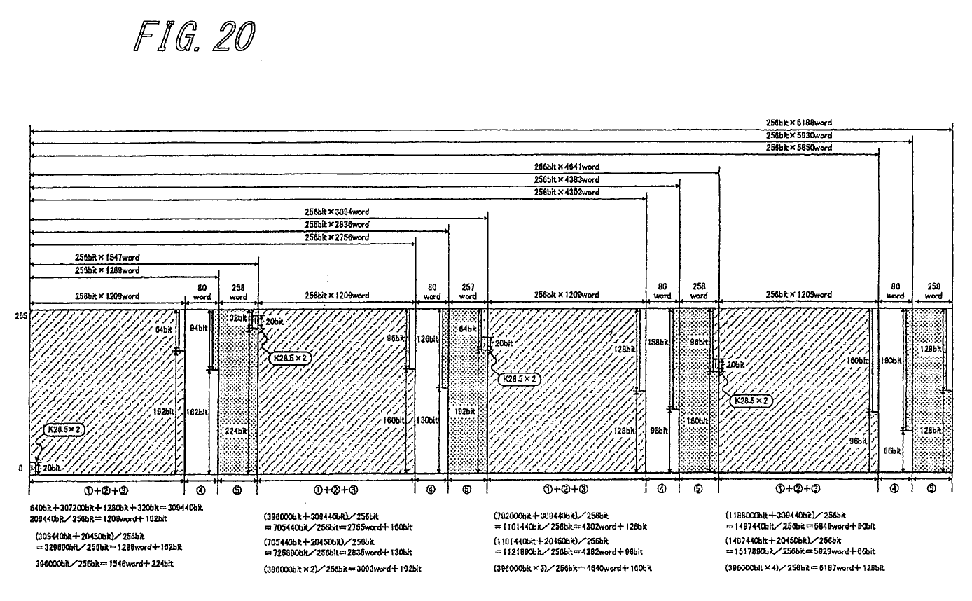

FIGS. 18 to 20 are diagram showing the structure of the 256-bit-width parallel digital data formed by the data length converting unit 15. FIG. 18 shows the data structure of one line for 30P. FIG. 19 shows the data structure of one line for 25P. FIG. 20 shows the data structure of four lines for 24P (four lines are shown since in the case of 24P, the number of bits of the final word in a four-line cycle is 128 bits). According to SMPTE 435, the frame rate and number of lines is the same as the HD-SDI signal on CH1. Also, although the S/P•scramble•8B/10B unit 12 is used for both the scrambling and eight-bit/ten-bit encoding of data, the channel CH1 is subjected to only scrambling (the scrambling used in SMPTE 292M). Accordingly, the data structure shown in FIGS. 18 to 20 is fundamentally the same as an HD-SDI signal.

As shown in FIGS. 18 to 20, the data on one line is composed of the following three regions:
obliquely-shaded region: a region of data of the timing reference signal SAV, the active line, the timing reference signal EAV, the line number LN, and the error detection code CRC on channels CH1 to CH8 multiplexed in 40-bit units in the order CH2, CH1, CH4, CH3, CH6, CH5, CH8, CH7;
white (unshaded) region: a region of data of the horizontal blanking interval in 50-bit pieces on CH1 that has been subjected to eight-bit/ten-bit encoding; and
dotted region: a region of data appended to adjust the data amount.

As shown in FIG. 2, the parallel digital data converted to a 128-bit width by the data length converting unit 15 is supplied to the FIFO memory 16 and is written into the FIFO memory 16 using the 83.5312 MHz clock from the PLL 13.

The 128-bit width parallel digital data written into the FIFO memory 16 is read from the FIFO memory 16 as 64-bit-width parallel digital data using the 167.0625 MHz clock from the PLL 13 shown in FIG. 2 and is supplied to the multichannel data forming unit 17.

As one example, the multichannel data forming unit 17 is an XSBI (Ten gigabit Sixteen Bit Interface: a sixteen bit interface that is used in a 10 gigabit ETHERNET® system). The multichannel data forming unit 17 uses the 668.25 MHz clock from the PLL 13 to form 16 channels of serial digital data with a bitrate of 668.25 Mbps from the 64-bit-width parallel digital data from the FIFO memory 16. The 16 channels of serial digital data formed by the multichannel data forming unit 17 are supplied to the multiplexing-parallel/serial converting unit 18.

The multiplexing-parallel/serial converting unit 18 multiplexes the 16 channels of serial digital data from the multichannel data forming unit 17 and carries out parallel to serial conversion on the multiplexed parallel digital data to generate 668.25 Mbps×16=10.692 Gbps serial digital data. The multiplexing-parallel/serial converting unit 18 in the present embodiment includes a function as a serial-parallel converting unit that converts the first, second, third, and fourth subimages mapped by the mapping unit 10 to serial data.

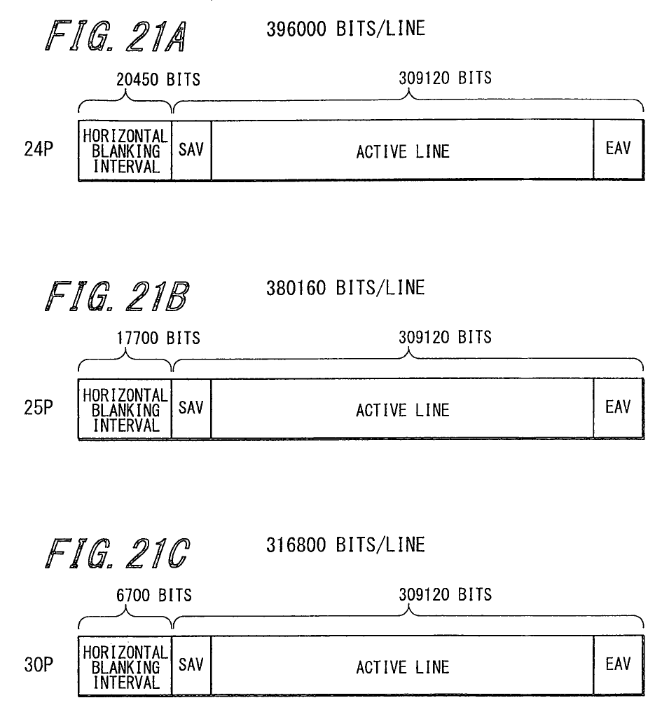

FIGS. 21A to 21C are diagrams showing the data structures of one line in such 10.692 Gbps serial digital data. FIG. 21A shows the data structure for 24P. FIG. 21B shows the data structure for 25P. FIG. 21C shows the data structure for 30P. In these diagrams, data including the line number LN and the error detection code CRC is shown as “SAV, active line, and EAV”, and data including the region of appended data in FIGS. 18 to 20 is shown as the “horizontal blanking interval”.

The number of bits on one line for 24P, 25P, and 30P are found according to the equations below.

10.692 Gbps÷24 frames/second÷1125 lines/frame=396,000 bits

10.692 Gbps÷25 frames/second÷1125 lines/frame=380,160 bits

10.692 Gbps÷30 frames/second÷1125 lines/frame=316,800 bits

The number of bits in the timing reference signal SAV, the active line, the timing reference signal EAV, the line number LN, and the error detection code CRC is found according to the following equation.

(1920T+12T)×36 bits×4ch×40/36=309120 bits

The respective numbers of bits in the horizontal blanking intervals for 24P, 25P, 30P are found according to the following equations.

(1) In the case of 24P: 396,000 bits−309,120 bits=86,880 bits

(2750T−1920T−12T(SAV+EAV+LN+CRC))×20 bits×10/8=20,450 bits

86,880 bits>20,450 bits

(2) In the case of 25P: 380,160 bits−309,120 bits=71,040 bits

(2640T−1920T−12T(SAV+EAV+LN+CRC))×20 bits×10/8=17,700 bits

71,040 bits>17,700 bits

(3) In the case of 30P: 316,800 bits−309,120 bits=7,680 bits

(22T−1920T−12T(SAV+EAV+LN+CRC))×20 bits×10/8=6,700 bits

7,680 bits>6,700 bits

As shown in the above equations, the respective numbers of bits in the horizontal blanking intervals according to SMPTE 435 for 24P, 25P, and 30P are 86,880 bits, 71,040 bits, and 7,680 bits. The numbers are larger than the numbers of bits resulted from calculating (the horizontal blanking interval minus (the data of the timing reference signal SAV, the timing reference signal EAV, the line number LN, and the error detection code CRC)) on channel CH1, i.e., 20,450 bits, 17,700 bits, and 6,700 bits, respectively. Accordingly, it is possible to multiplex the data of the horizontal blanking interval of channel CH1.

As shown in FIG. 2, the serial digital data with a bitrate of 10.692 Gbps that has been generated by the multiplexing-parallel/serial converting unit 18 is supplied to a photoelectric converting unit 19. The photoelectric converting unit 19 functions as an output unit that outputs serial digital data with a bitrate of 10.692 Gbps to the CCU 2. Serial digital data with a bitrate of 10.692 Gbps that has been converted to an optical signal by the photoelectric converting unit 19 is transmitted from the broadcasting camera 1 to the CCU 2 via the fiber optic cable 3 as shown in FIG. 1.

By using the signal transmitting apparatuses 5 according to the present embodiment, it is possible to carry out signal processing at a transmitter side that transmits a 3840×2160/24P, 25P, 30P/4:4:4, 4:2:2, 4:2:0/10-bit, 12-bit signal as serial digital data. The respective signal transmitting apparatuses 5 each map a 3840×2160/24P, 25P, 30P/4:4:4, 4:2:2, 4:2:0/10-bit, 12-bit signal to HD-SDI signals on the channels CH1 to CH8 (CH1, CH3, CH5, CH7 on LinkA and CH2, CH4, CH6, CH8 on LinkB). The respective HD-SDI signals are subjected to serial/parallel conversion, and then LinkA is subjected to self-synchronizing scrambling and the RGB bits on Link B are subjected to eight-bit/ten-bit encoding.

On LinkA, instead of subjecting all of the data on every horizontal line to self-synchronizing scrambling, self-synchronizing scrambling is carried out only on the timing reference signal SAV, the active line, the timing reference signal EAV, the line number LN, and the error detection code CRC, and self-synchronizing scrambling is not carried out on the data of the horizontal blanking interval. Encoding is carried out after setting the value in the register in the scrambler at all zeroes immediately before the timing reference signal SAV and data is outputted up to at least a few bits following the error detection code CRC.

Scrambling is carried out in this way for the following reason. Although transmission is carried out for all of the data of each horizontal line without interruptions according to existing self-synchronizing scrambling, with the present embodiment, data of the horizontal blanking interval that has been subjected to self-synchronizing scrambling is not transmitted. To achieve this, it is possible to use a method that scrambles all of the data on every horizontal line including the horizontal blanking interval but then does not transmit only the horizontal blanking interval. However, with such method, since data is not kept continuous for the transmission scrambler and the reception descrambler, when data is reproduced by the descrambler at the receiver, miscalculation of a carry may occur at the final few bits of the CRC, and therefore the error detection code CRC may not be correctly reproduced. Also, although there is a method that can correctly reproduce the CRC by stopping the clock of a scrambler in a horizontal blanking interval where data is not transmitted, when such method is used, the next timing reference signal SAV is necessary when calculating the CRC and that timing control may be difficult.

For this reason, only the data of the timing reference signal SAV, the active line, the timing reference signal EAV, the line number LN, and the error detection code CRC is scrambled. Encoding is carried out having set the value in the register in the scrambler at all zeroes immediately before the timing reference signal SAV, and data is outputted until at least a few bits following the error detection code CRC.

By doing so, the receiver apparatus starts decoding having set the value in the register in the descrambler at all zeroes immediately before the timing reference signal SAV and carries out descrambling also for at least a few bits of data following the error detection code CRC. Accordingly, it is possible to reproduce the original data by correctly carrying out calculation having considered a carry at the descrambler that is a multiplication circuit.

In addition, since it has been established by calculation that pathological patterns do not occur in the scrambled data if the value in the register in the scrambler is set at all zeroes immediately before the timing reference signal SAV, the resulting signal can be regarded as suitable transmission code.

On LinkB, in the data on each horizontal line, the RGB bits are extracted from only the data of the timing reference signal SAV, the active line, the timing reference signal EAV, the line number LN, and the error detection code CRC, with such RGB bits then being subjected to eight-bit/ten-bit encoding. Subsequently, the data on LinkA that has been subjected to self-synchronizing scrambling as described above and the data on LinkB that has been subjected to eight-bit/ten-bit encoding as described above are multiplexed and serial digital data with a bitrate of 10.692 Gbps is generated from the multiplexed parallel digital data.

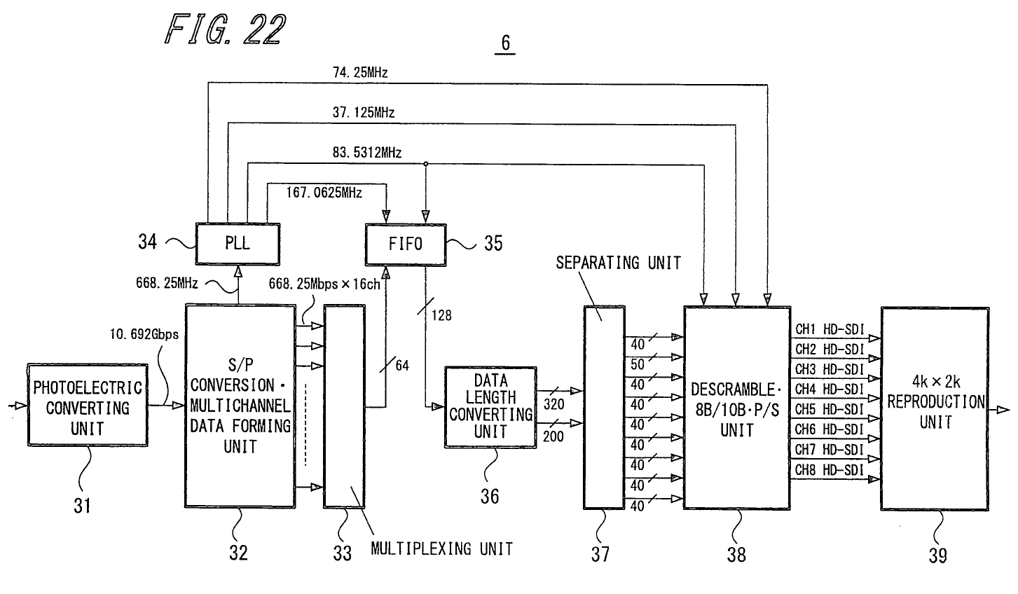

FIG. 22 is a block diagram showing the part, which relates to the present embodiment, of the circuit configuration of the CCU 2. In the CCU 2, a plurality of circuits shown in FIG. 22 are provided so as to one-to-one correspond to the broadcasting cameras 1.

The serial digital data with a bitrate of 10.692 Gbps that has been transmitted from a broadcasting camera 1 via a fiber optic cable 3 is converted to an electric signal by a photoelectric converting unit 31 and is then supplied to a S/P conversion-multichannel data forming unit 32. As one example, the S/P conversion-multichannel data forming unit 32 is an XSBI described earlier. The S/P conversion-multichannel data forming unit 32 receives the first, second, third, and fourth subimages that have been produced by mapping an image signal and have been divided between the first link channel and the second link channel.

The S/P conversion-multichannel data forming unit 32 subjects the serial digital data with a bitrate of 10.692 Gbps to serial/parallel conversion and, from the parallel digital data produced by the serial/parallel conversion, forms sixteen channels of serial digital data with a bitrate of 668.25 Mbps and extracts a 668.25 MHz clock.

The sixteen channels of parallel digital data formed by the S/P conversion-multichannel data forming unit 32 are supplied to a multiplexing unit 33. The 668.25 MHz clock extracted by the S/P conversion-multichannel data forming unit 32 is supplied to the PLL 34.

The multiplexing unit 33 multiplexes the sixteen channels of serial digital data from the S/P conversion-multichannel data forming unit 32 and supplies the resulting 64-bit-wide parallel digital data to a FIFO memory 35.

The PLL 34 supplies a 167.0625 MHz clock produced by dividing the 668.25 MHz clock from the S/P conversion-multichannel data forming unit 32 into one quarter as a write clock to the FIFO memory 35.

The PLL 34 also supplies an 83.5312 MHz clock produced by dividing the 668.25 MHz clock from the S/P conversion-multichannel data forming unit 32 into one eighth as a read clock to the FIFO memory 35, and supplies the same clock as a write clock to a FIFO memory 44 in an descramble•8B/10B•P/S unit 38, described later.

The PLL 34 also supplies a 37.125 MHz clock produced by dividing the 668.25 MHz clock from the S/P conversion-multichannel data forming unit 32 into one eighteenth as a read clock to the FIFO memory 44 in the descramble•8B/10B•P/S unit 38 and supplies the same clock as a write clock to a FIFO memory 45 in the descramble•8B/10B•P/S unit 38.

The PLL 34 also supplies a 74.25 MHz clock produced by dividing the 668.25 MHz clock from the S/P conversion-multichannel data forming unit 32 into one ninth as a read clock to the FIFO memory 45 in the descramble•8B/10B•P/S unit 38.

The 64-bit-wide parallel digital data from the multiplexing unit 33 is written into the FIFO memory 35 using the 167.0625 MHz clock from the PLL 34. The parallel digital data written into the FIFO memory 35 is read as 128-bit-wide parallel digital data using the 83.5312 MHz clock from the PLL 34 and is supplied to a data length converting unit 36.

The data length converting unit 36 is formed of a shift register and converts the 128-bit-wide parallel digital data to 256-bit-wide data (i.e., data with the structure shown in FIGS. 18 to 20). Next, each line period is identified by detecting the K28.5 inserted into the timing reference signal SAV or EAV, the data of the timing reference signal SAV, the active line, the timing reference signal EAV, the line number LN, and the error detection code CRC is converted to 320 bits wide. In addition, the data of the horizontal blanking interval (as described earlier, data of the horizontal blanking interval of channel CH1 that has been subjected to eight-bit/ten-bit encoding) is converted to 200-bit-wide data. The appended data shown in FIGS. 18 to 20 is discarded.

The 320-bit-wide parallel digital data and the 200-bit-wide parallel digital data whose data lengths have been converted by the data length converting unit 36 are supplied to a separating unit 37.

The separating unit 37 separates the 320-bit-wide parallel digital data (the data of the timing reference signal SAV, the active line, the timing reference signal EAV, the line number LN, and the error detection code CRC) from the data length converting unit 36 into the data of the channels CH1 to CH8 (see FIG. 17A) in 40-bit pieces before multiplexed by the multiplexing unit 14 (see FIG. 2) in the broadcasting camera 1. Subsequently, the 40-bit-wide parallel digital data of the respective channels CH1 to CH8 is supplied to the descramble•8B/10B•P/S unit 38.

The separating unit 37 separates the 200-bit-wide parallel digital data (i.e., data of the horizontal blanking interval of channel CH1 that has been subjected to eight-bit/ten-bit encoding) from the data length converting unit 36 into the 50-bit pieces of data (see FIG. 17B) before multiplexed by the multiplexing unit 14. Subsequently, the 50-bit-wide parallel digital data is supplied to the descramble•8B/10B•P/S unit 38.

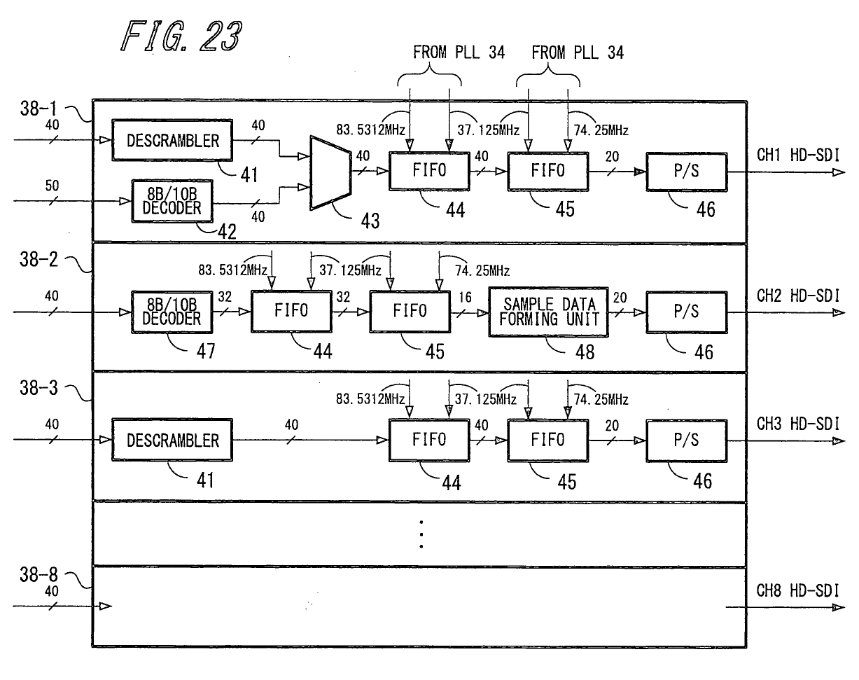

FIG. 23 is a block diagram showing the configuration of the descramble•8B/10B•P/S unit 38. The descramble•8B/10B•P/S unit 38 is composed of eight blocks 38-1 to 38-8 that one-to-one correspond to the channels CH1 to CH8. The descramble8B/10B•P/S unit 38 in the present embodiment functions as a receiver unit that receives the first, second, third, and fourth subimages onto which an image signal has been mapped and which have been divided between the first link channel and the second link channel.

In the blocks 38-1, 38-3, 38-5, and 38-7 for the channels CH1, CH3, CH5, and CH7 on LinkA, only the configuration of the block 38-1 differs from the configuration of the blocks 38-3, 38-5, and 38-7, and the blocks 38-3, 38-5, and 38-7 all have the same configuration (in FIG. 23, only the configuration of the block 38-3 is shown and the configurations of the blocks 38-5 and 38-7 are omitted). The blocks 38-2, 38-4, 38-6, and 38-8 for the channels CH2, CH4, CH6, and CH8 on LinkB all have the same configuration (in FIG. 23, only the configuration of the block 38-2 is shown and the configurations of the blocks 38-4, 38-6 and 38-8 are omitted). Parts that carry out the same processing in the respective blocks are assigned the same reference numerals.

First, blocks 38-1, 38-3, 38-5, and 38-7 for LinkA will be described. In each of the blocks 38-1, 38-3, 38-5, and 38-7, the inputted 40-bit-wide parallel digital data on the channel CH1, CH3, CH5, or CH7 (that is, the data of the timing reference signal SAV, the active line, the timing reference signal EAV, the line number LN, and the error detection code CRC that has been subjected to self-synchronizing scrambling) is supplied to a descrambler 41.

Each descrambler 41 is a self-synchronizing descrambler. The descrambler 41 descrambles the parallel digital data that has been supplied, but commences the decoding after setting the value in the register in the descrambler 41 at all zeroes immediately before the timing reference signal SAV and carries out self-synchronizing descrambling for 10 bits of data that follow the error detection code CRC.

By doing so, as described for the scrambler 24 (see FIG. 13) in each broadcasting camera 1, in spite of the data of the horizontal blanking interval that has been subjected to self-synchronizing scrambling not being transmitted, it is possible to reproduce the original data by correctly carrying out calculation having considered a carry at the descrambler 41 that is a multiplication circuit.

The descrambler 41 carries out the self-synchronizing descrambling and then changes the value of the least significant two bits of XYZ in the timing reference signal SAV (as described above for the scrambler 24, the bits that were scrambled after being set at different values on the respective channels CH1, CH3, CH5, CH7) to (0,0) that is the original value.

The 40-bit-wide parallel digital data that has been subjected to descrambling by the descrambler 41 in the block 38-1 is supplied to a selector 43. In the block 38-1, the inputted 50-bit-wide parallel digital data (that is, data of the horizontal blanking interval of channel CH1 that has been subjected to eight-bit/ten-bit encoding) is supplied to an eight-bit/ten-bit decoder 42. The eight-bit/ten-bit decoder 42 carries out eight-bit/ten-bit decoding on the parallel digital data. The 40-bit-wide parallel digital data that results from the eight-bit/ten-bit decoding by the eight-bit/ten-bit decoder 42 is supplied to the selector 43.

By alternately selecting the parallel digital data from the descrambler 41 and the parallel digital data from the eight-bit/ten-bit decoder 42, the selector 43 forms 40-bit-wide parallel digital data where all of the data on every horizontal line has been integrated, and supplies such 40-bit-wide parallel digital data to the FIFO memory 44.

On the other hand, in blocks 38-3, 38-5, and 38-7, since 50-bit-wide parallel digital data is not inputted, the eight-bit/ten-bit decoder 42 and the selector 43 are not provided and the 40-bit-wide parallel digital data that has been descrambled by the descrambler 41 is directly supplied to the FIFO memory 44.

The 40-bit-wide parallel digital data supplied to the FIFO memory 44 has been written into the FIFO memory 44 using the 83.5312 MHz clock from the PLL 34 (see FIG. 22). Subsequently, the 40-bit-wide data is directly read from the FIFO memory 44 using the 37.125 MHz clock from the PLL 34 and is supplied to the FIFO memory 45.

The 40-bit-wide parallel digital data supplied to the FIFO memory 45 has been written in the FIFO memory 45 using the 37.125 MHz clock from the PLL 34 (see FIG. 22). Subsequently, the data is read from the FIFO memory 45 as 20-bit-wide parallel digital data (one sample at a time on LinkA shown in FIG. 7A) using the 74.25 MHz clock from the PLL 34 and is supplied to a parallel/serial converting unit 46.

The parallel/serial converting unit 46 subjects such parallel digital data to parallel/serial conversion to produce an HD-SDI signal with a bitrate of 1.485 Gbps, thereby reproducing an HD-SDI signal. The HD-SDI signals on the channels CH1, CH3, CH5, and CH7 reproduced by the blocks 38-1, 38-3, 38-5, and 38-7 are transmitted to a 4k×2k reproduction unit 39 shown in FIG. 22.

Next, blocks 38-2, 38-4, 38-6, and 38-8 for LinkB will be described. In the blocks 38-2, 38-4, 38-6, and 38-8, the inputted 40-bit-wide parallel digital data (the data of timing reference signal SAV, the active line, the timing reference signal EAV, the line number LN, and the error detection code CRC that has been subjected to eight-bit/ten-bit encoding) on the channels CH2, CH4, CH6, or CH8 is supplied to an eight-bit/ten-bit decoder 47.

The eight-bit/ten-bit decoder 47 carries out eight-bit/ten-bit decoding on the parallel digital data. The 32-bit-wide parallel digital data that results from the eight-bit/ten-bit decoding by the eight-bit/ten-bit decoder 47 is supplied to the FIFO memory 44.

After the 32-bit-wide parallel digital data supplied to the FIFO memory 44 has been written into the FIFO memory 44 using the 83.5312 MHz clock from the PLL 34 (see FIG. 22), the 32-bit-wide data is read from the FIFO memory 44 using the 37.125 MHz clock from the PLL 34 and supplied to the FIFO memory 45.

After the 32-bit-wide parallel digital data supplied to the FIFO memory 45 has been written into the FIFO memory 45 using the 37.125 MHz clock from the PLL 34 (see FIG. 22), 16-bit-wide parallel digital data (i.e., RGB bits for one sample on LinkB shown in FIG. 7A) is read from the FIFO memory 45 using the 74.25 MHz clock from the PLL 34 and supplied to a sample data forming unit 48.

The sample data forming unit 48 forms the data of each 20-bit sample on LinkB from the RGB bits of LinkB by appending four bits with the bit numbers 0, 1, 8, and 9 in the R′G′B′n:0-1 shown in FIG. 7B. The 20-bit-wide parallel digital data formed in this way is supplied from the sample data forming unit 48 to the parallel/serial converting unit 46.

The parallel/serial converting unit 46 subjects the parallel digital data to parallel/serial conversion to produce a HD-SDI signal with a bitrate of 1.485 Gbps, thereby reproducing an HD-SDI signal. The HD-SDI signals on the channels CH2, CH4, CH6, and CH8 reproduced by the blocks 38-2, 38-4, 38-6, and 38-8 are supplied to the 4k×2k reproduction unit 39 shown in FIG. 22.

The 4k×2k reproduction unit 39 shown in FIG. 22 carries out the opposite processing to the processing (see FIG. 6) of the mapping unit 10 (see FIG. 2) in a broadcasting camera 1 according to SMPTE 435 on the HD-SDI signals on channels CH1 to CH8 (LinkA and LinkB) supplied from the descramble•8B/10B•P/S unit 38. According to this processing, the 3840×2160/24P, 25P, 30P/4:4:4, 4:2:2, 4:2:0/10-bit, 12-bit signal is reproduced.

The 4k×2k reproduction unit 39 according to the present embodiment extracts pixel samples arranged in the active periods of the first, second, third, and fourth subimages received by the S/P conversion-multichannel data forming unit 32 one sample at a time. Subsequently, the samples are arranged in order within one frame of the image signal and any pixels that were thinned out from arranged samples are restored.

When doing so, the 4k×2k reproduction unit 39 arranges the samples that were mapped onto the first subimage and the second subimage alternately on odd-numbered lines. In the same way, the 4k×2k reproduction unit 39 arranges the samples that were mapped onto the third subimage and the fourth subimage alternately on even-numbered lines. Also, from the samples arranged on the respective lines, any thinned-out pixels adjacent to such samples are restored.

The 3840×2160/24P, 25P, 30P/4:4:4, 4:2:2, 4:2:0/10-bit, 12-bit signal recovered by the 4k×2k reproduction unit 39 is outputted from the CCU 2 and transmitted to a VTR (not shown) or the like.

Note that not only a 3840×2160/24P, 25P, 30P/4:4:4, 4:2:2, 4:2:0/10-bit, 12-bit signal is transmitted from a broadcasting camera 1 to the CCU 2 as described above, but also the return video described earlier (i.e., an image signal for displaying images being picked up by other broadcasting cameras 1) is transmitted via the fiber optic cables 3 from the CCU 2 to the respective broadcasting cameras 1. However, since such return video is generated using well-known technology (for example, subjecting HD-SDI signals on two channels to eight-bit/ten-bit encoding, multiplexing the resulting data, and then converting the data to serial digital data), description of the circuit configuration therefor is omitted here.

A signal receiving apparatus 6 according to the present embodiment carries out signal processing to receive the serial digital data generated by the signal transmitting apparatuses 5. The signal receiving method of the signal receiving apparatus 6 generates parallel digital data from serial digital data with a bitrate of 10.692 Gbps and separates the parallel digital data into data of the respective channels on LinkA and LinkB.

Although the data on LinkA that has been separated is subjected to self-synchronizing descrambling, the decoding is commenced after the value of the register in the descrambler is set at all zeroes immediately before the timing reference signal SAV, and at least a few bits of data that follow the error detection code CRC are also subjected to self-synchronizing descrambling. Accordingly, even though only the data of the timing reference signal SAV, the active line, the timing reference signal EAV, the line number LN, and the error detection code CRC is subjected to self-synchronizing scrambling and the data of the horizontal blanking interval is not subjected to self-synchronizing scrambling, it is possible to reproduce the original data by correctly carrying out calculation having considered a carry at the descrambler that is a multiplication circuit.

For the data on LinkB that has been separated, the data of each sample on LinkB is formed from the RGB bits that have been subjected to eight-bit/ten-bit decoding. The parallel digital data on LinkA that has been subjected to self-synchronizing descrambling and the parallel digital data on LinkB that forms each sample are subjected to parallel/serial conversion to reproduce the HD-SDI signals of the channels CH1 to CH8 that have been mapped.

As described above, at a broadcasting camera 1 that is the transmitter, encoding is carried out after setting the value of the register in the scrambler 24 at all zeroes immediately before the timing reference signal SAV and data is outputted up to ten bits following the error detection code CRC. At the CCU 2 that is the receiver, decoding is commenced after setting the value of the register in the descrambler 41 at all zeroes immediately before the timing reference signal SAV and ten bits of data that follow the error detection code CRC are also subjected to descrambling. Accordingly, it is possible to correctly reproduce the original data at the CCU 2 that is the receiver even though data of the horizontal blanking interval that has been subjected to self-synchronizing scrambling is not transmitted.

On both LinkA and LinkB, since self-synchronizing scrambling and eight-bit/ten-bit encoding are carried out for units of two samples, it is possible to achieve compatibility with the most significant 40 bits of a 50-bit Content ID according to SMPTE 435.

Also, scrambling having changed the value of the least significant two bits of XYZ within the timing reference signal SAV on each channel on LinkA is carried out. Therefore, even when the 3840×2160/24P, 25P, 30P/4:4:4, 4:2:2, 4:2:0/10-bit, 12-bit signal is a flat signal (that is, when the RGB values are substantially the same across the entire screen), the data values on channels CH1, CH3, CH5, and CH7 and channels CH2, CH4, CH6, and CH8 can be avoided to become uniform, and EMI (Electromagnetic Interference) can be prevented.

Further, the occurrence of pathological patterns can be prevented by inserting data that has been subjected to eight-bit/ten-bit encoding at intervals of 40 bits into the data that has been subjected to self-synchronizing scrambling and setting the value in the register in the descrambler 41 at all zeroes immediately before the timing reference signal SAV.

The camera transmission system according to the present embodiment described above is suitable when synchronized HD-SDI signals transmitted on a plurality of channels are inputted into and outputted from a signal input unit.

The HD-SDI signals on other channels aside from the HD-SDI signal on the first channel can be transmitted using a typical input/output device without using a high-speed dedicated input/output device. Also, since it is not necessary to supply a clock from the periphery to such typical input/output devices, the power consumption of clock transmission/reception units can be eliminated. In addition, when transmitting HD-SDI signals on a large number of channels, the number of signal lines and phase (i.e., length) of pair lines are important design issues. Therefore, according to an embodiment of the present invention, there are the advantageous effects that it is not necessary to lay out the data lines and clock lines with equal lengths, and clock signal lines may not need to be provided. In the signal input unit, data can be extracted not only from signals differentially transmitted, but also from signals transmitted according to a variety of methods.

The number of high-speed input/output ports included in an existing FPGA is a low number such as eight to sixteen or twenty-four channels. Also, FPGAs that include a large number of high-speed input/output ports are costly. However, for the signal inputting unit 11 according to the present embodiment, so long as one port is capable of inputting and outputting signals at high speed, typical input/output ports can be used as the other ports. This results in the effect that it is possible to use a low-cost configuration for the signal inputting unit and to simplify the configuration.

Note that although the present invention has been applied to a camera transmission system in the embodiment described above, it is also possible to apply the present invention to transmitting signals according to a variety of other methods. The present invention can be applied when transmitting a variety of signals.

It should be understood by those skilled in the art that various modifications, combinations, sub-combinations and alterations may occur depending on design requirements and other factors insofar as they are within the scope of the appended claims or the equivalents thereof.

What is claimed is:

1. A signal inputting apparatus that receives first and second input image signals transmitted and extracts image data, comprising:
a first interface unit configured to receive a first input image signal transmitted, extract data from the first input image signal, and generate a recovered clock from the first input image signal; and
a second interface unit configured to receive a second input image signal transmitted in synchronization with the first input image signal and extract data from the transmitted second input image signal based on the recovered clock supplied from the first interface unit.

2. A signal inputting apparatus according to claim 1, wherein
the first interface unit includes:
a clock recovery unit configured to recover the clock from the received first input image signal;
a first clock phase shift unit configured to shift a phase of the clock recovered by the clock recovery unit to synchronize the phase with the first input image signal and supply the clock to the second interface unit;
a first waveform shaping unit configured to shape a waveform of the first input image signal based on the recovered clock shifted by the first clock phase shift unit; and
a first serial-parallel converting unit configured to convert the first input image signal shaped by the first waveform shaping unit to parallel data.

3. A signal inputting apparatus according to claim 2, wherein
the first interface unit further includes a first error determining unit configured to determine errors in the first input image signal converted by the first serial-parallel converting unit and supply an error determination signal generated based on the determined presence/absence of errors to the first clock phase shift unit.

4. A signal inputting apparatus according to claim 2, further comprising:
an FPGA including a dedicated high-speed input/output port,
wherein the first interface unit is assigned to the dedicated high-speed input/output port of the FPGA.

5. A signal inputting apparatus according to claim 2, wherein
the second interface unit includes:
a second clock phase shift unit configured to shift a phase of the clock supplied from the clock recovery unit of the first interface unit to synchronize the phase with the second input image signal;
a second waveform shaping unit configured to shape a waveform of the second input image signal based on the recovered clock shifted by the second clock phase shift unit; and
a second serial•parallel converting unit configured to convert the second input image signal shaped by the second waveform shaping unit to parallel data.

6. A signal inputting apparatus according to claim 5,
wherein the second interface unit further includes a second error determining unit configured to determine errors in the second input image signal converted by the second serial•parallel converting unit and supply an error determination signal generated based on the determined presence/absence of errors to the second clock phase shift unit.

7. A signal inputting method comprising the steps of:
receiving transmitted first and second input image signals using first and second interface units;
extracting data from the first input image signal and generating a recovered clock from the first input image signal using the first interface unit; and
extracting data from the second input image signal using the second interface unit in synchronization with the first input image signal based on the recovered clock supplied from the first interface unit.
